(19) United States
(12) Patent Application Publication
(10) Pub. No.: US 2017/0283701 A1
(43) Pub. Date: Oct. 5, 2017

(54) POLYMER, COMPOSITION, OPTICAL FILM, AND LIQUID CRYSTAL DISPLAY DEVICE

(71) Applicant: FUJIFILM Corporation, Tokyo (JP)

(72) Inventors: Akio TAMURA, Kanagawa (JP); Koji IIJIMA, Kanagawa (JP)

(73) Assignee: FUJIFILM Corporation, Tokyo (JP)

(21) Appl. No.: 15/618,725

(22) Filed: Jun. 9, 2017

Related U.S. Application Data
(63) Continuation of application No. PCT/JP2015/006141, filed on Dec. 9, 2015.

(30) Foreign Application Priority Data
Dec. 12, 2014 (JP) 2014-252480

(51) Int. Cl. C09K 19/54; G02F 1/1335; C09K 19/34; G02F 1/1333; C08F 220/24; C08F 222/10

(52) U.S. Cl. CPC C09K 19/544; C08F 220/24; C08F 222/1006; C09K 19/3477; G02F 1/133365; G02F 1/1336; C08F 2222/1026; C08F 2222/1013; C09K 2019/528

(57) ABSTRACT

A polymer is obtained by polymerizing a monomer having two or more radical polymerizable double bonds and one or more hydroxyl groups. A composition including the polymer, an optical film including a cholesteric liquid crystal layer containing the polymer on a support, and a liquid crystal display device including at least a backlight unit including the optical film and a liquid crystal cell are provided.

### CROSS-REFERENCE TO RELATED APPLICATIONS

This application is a continuation application of International Application No. PCT/JP2015/006141, filed Dec. 9, 2015, the disclosure of which is incorporated herein by reference in its entirety. Further, this application claims priority from Japanese Patent Application No. 2014-252480, filed Dec. 12, 2014, the disclosure of which is incorporated herein by reference in its entirety.

### BACKGROUND OF THE INVENTION

### 1. Field of the Invention

The present invention relates to a polymer, a composition, an optical film, and a liquid crystal display device.

### 2. Description of the Related Art

In recent years, polymer materials have been used in various fields. Along with this, depending on respective fields, not only the properties of a polymer as a matrix, but also characteristics of the surface of a coating film formed by adding the polymer, or the interface of a laminated film in the case of laminating a coating film, have become important. For example, semiconductor components, optical members, liquid crystal-related members and the like are often produced by laminating a coating film. In order to improve the wettability of the coating composition and the smoothness of the coating film surface, or the wettability in the case of applying a composition of an upper layer to the coating film surface, a silicone-based or fluorine-based surfactant may be added to the composition in some cases.

As the fluorine-based surfactant, for example, JP2000-102727A proposes a fluorine-based surfactant including a polymer (I) obtained by polymerizing a fluorinated alkyl group-containing ethylenically unsaturated monomer (A) as an essential component, and a polymer (II) obtained by polymerizing a predetermined amount of a fluorinated alkyl group-containing ethylenically unsaturated monomer (A) and a hydrophilic structural unit-containing ethylenically unsaturated monomer (B) as essential components. According to the disclosure, excellent wettability, homogeneous coatability, and post-processing suitability such as recoatability and developability can be attained.

On the other hand, in recent years, so-called three-dimensional dendritic polymers (also referred to as dendritic polymers) such as dendrimers and highly branched polymers have different properties from the properties of typical linear polymers, and the application thereof has attracted attention. When a dendritic polymer is synthesized by radically polymerizing a divinyl monomer-containing system, the monomer is cross-linked and thus an insoluble and infusible polymer is produced. In Functional Materials, Tuneyuki Sato, University of Tokushima, Vol. 26, No. 8, pp. 44-52, August, 2006, an initiator-incorporated radical polymerization for polymerizing a monomer under the presence of a high concentration radical polymerization initiator is proposed. It is disclosed that since the polymer prepared by this method is highly branched, the melt viscosity and solution viscosity are low and the solubility is high.

### SUMMARY OF THE INVENTION

However, while the fluorine-based surfactant or the silicone-based surfactant lowers the surface tension of the coating film and satisfactorily improves coatability at the time of coating film formation, the surface energy is low and thus the surfactant tends to be unevenly distributed on the surface of the coating film. Since such a surface has high water and oil repellency, when a laminated film is further tried to be prepared by applying an upper layer to form a layer, so-called cissing in which the coating solution is repelled on the coating surface to induce failure in application occurs. As a method of preventing cissing, suppressing fluidity by increasing the viscosity of the coating solution is considered. However, generally, when the viscosity is high, there is a problem of forming a homogeneous coating film.

The fluorine-based surfactant is also used for coating films such as optical films of liquid crystal display devices (LCD). Some of optical films are prepared by applying a material including a liquid crystal compound containing a fluorine-based surfactant to a base film or an alignment film in some cases. However, the compatibility between the fluorine-based surfactant and the liquid crystal compound is poor and polymer aggregation occurs, thereby causing a problem of an increase in haze. In addition, in the case in which the fluorine-based surfactant is added to the alignment film, cissing easily occurs. When cissing occurs, the orientation restricting force of the alignment film hardly acts at the interface not in contact with the alignment film and there is a problem of the occurrence of orientation defects.

It may be difficult to use surfactants other than the fluorine-based surfactant and resin modifiers as an additive since the solubility deteriorates. Thus, it is desired to develop a novel material that can improve wettability at the time of application.

In consideration of the above circumstances, an object of the present invention is to provide a polymer that improves the wettability of a coating solution and hardly causes cissing when being used as a surfactant or a resin modifier to be added to the coating solution. In addition, another object thereof is to provide a composition including such a polymer and having excellent recoatability.

Still another object of the present invention is to provide an optical film that can function as a support film for preparing a laminated film or the like, hardly causes cissing of a coating solution for forming an upper layer, and having a surface with a good surface condition and reduced orientation defects, and a liquid crystal display device including the optical film.

As a result of intensive investigations to solve the above problems, the present inventors have found that a polymer obtained by polymerizing a monomer which is a bifunctional or polyfunctional compound and contains a hydroxyl group exhibits good compatibility with a matrix resin or various additives and suppresses aggregation and haze at the time of addition. Further, when the polymer is added to a composition for an optical functional film having a laminated structure and applied to the base film or optical functional layer in a laminated manner, cissing does not occur both at the time of application of an underlayer and the time of application of an upper layer, and good coatability is exhibited. In addition, it has been found that the surface of the obtained film does not have orientation defects and the surface condition of the film is good. Thus, the present invention has been accomplished.

That is, the polymer of the present invention is a polymer obtained by polymerizing a monomer having two or more radical polymerizable double bonds and one or more hydroxyl groups.

It is preferable that the monomer is represented by the following Formula X.

Z^{X1}-L^{X1}-L^{X2}-ML^{X3}-L^{X4}-Z^{X2})ₙ Formula X

In Formula X, Z^{X1} and Z^{X2} each independently represent a group having a radical polymerizable double bond, L^{X1} and L^{X4} each independently represent a single bond or an alkylene group having a hydroxyl group, L^{X2} and L^{X3} each independently represent a single bond or a divalent linking group including at least one selected from the group consisting of —O—, —(C═O)O—, —O(C═O)—, a divalent chained group, an alkylene group having a hydroxyl group, and a divalent cyclic aliphatic group, M represents a single bond or a divalent to tetravalent linking group, and n represents an integer of 1 to 3.

It is preferable that the monomer is represented by the following Formula X1.

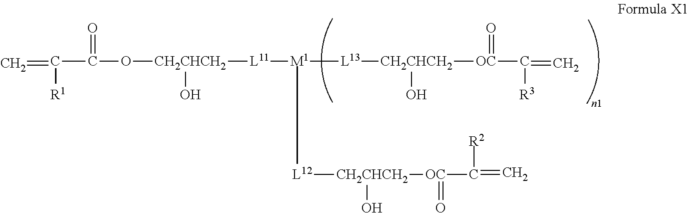

In Formula X1, R¹, R², and R³ each independently represent a hydrogen atom or an alkyl group having 1 to 20 carbon atoms, L¹¹, L¹², and L¹³ each independently represent a single bond or a divalent linking group including at least one selected from the group consisting of —O—, —(C═O)O—, —O(C═O)—, a divalent chained group, an alkylene group having a hydroxyl group, and a divalent cyclic aliphatic group, and n1 represents an integer of 0 to 2.

It is preferable that the polymer of the present invention has a partial structure formed by polymerizing a compound having a fluorine atom.

It is preferable that the compound having a fluorine atom is represented by the following Formula a.

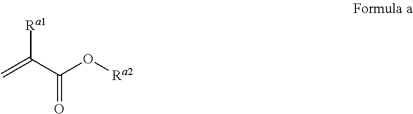

In Formula a, R^{a1} represents a hydrogen atom or an alkyl group having 1 to 20 carbon atoms, and R^{a2} represents an alkyl group having 1 to 20 carbon atoms of which at least one carbon atom has a fluorine atom as a substituent.

It is preferable that the weight-average molecular weight of the polymer of the present invention is 1,000 to 300,000 in terms of polystyrene by gel permeation chromatography.

It is preferable that the weight-average molecular weight of the polymer of the present invention is 1,000 to 10,000 in terms of polystyrene by gel permeation chromatography.

It is preferable that the polymer of the present invention has a highly branched structure.

A composition of the present invention comprises the polymer of the present invention.

The composition of the present invention may further comprise a liquid crystal compound.

It is preferable that the liquid crystal compound is a polymerizable liquid crystal compound.

It is preferable that the polymerizable liquid crystal compound is at least one of a polymerizable rod-like liquid crystal compound or a polymerizable disk-like liquid crystal compound.

An optical film of the present invention comprises a cholesteric liquid crystal layer containing the polymer of the present invention.

In addition, the optical film of the present invention may have a structure formed by laminating a plurality of the cholesteric liquid crystal layers.

Here, the cholesteric liquid crystal layer refers to a layer in which the phase of the liquid crystal compound is fixed in cholesteric alignment by applying and drying a composition including a liquid crystal compound and then curing the composition.

In addition, one of the plurality of cholesteric liquid crystal layers may be a cholesteric liquid crystal layer including a rod-like liquid crystal compound and the other may be a cholesteric liquid crystal layer including a disk-like liquid crystal compound.

It is preferable that the cholesteric liquid crystal layer including the rod-like liquid crystal compound and the cholesteric liquid crystal layer including the disk-like liquid crystal compound are in contact with each other.

A liquid crystal display device of the present invention comprises at least a backlight unit including the optical film of the present invention and a liquid crystal cell.

The polymer of the present invention is obtained by polymerizing a monomer having two or more radical polymerizable double bonds and one or more hydroxyl groups. Since the polymer has the above constitution, in the case of using the polymer of the present invention by adding the polymer to the coating solution, good compatibility with other materials is attained. Further, since the polymer has a hydroxyl group, the polymer has polarity and the affinity with a surface to be coated increases so that wettability is improved. Therefore, cissing hardly occurs. In addition, since the hydroxyl group is present on the surface of the coating film, even in the case of laminating the upper layer by application, the cissing of the coating solution hardly occurs. That is, the recoatability is excellent.

In addition, the optical film including such a polymer has a surface with a good surface condition and reduced orientation defects.

### BRIEF DESCRIPTION OF THE DRAWINGS

FIG. 1 is a schematic cross-sectional view showing an optical film of an embodiment according to the present invention.

FIG. 2 is a schematic view showing the configuration of a liquid crystal display device of an embodiment according to the present invention.

FIG. 3 is a schematic cross-sectional view showing a backlight in the liquid crystal display device of the embodiment according to the present invention.

### DESCRIPTION OF THE PREFERRED EMBODIMENTS

The following description is based on representative embodiments of the present invention, but the present invention is not limited to such embodiments. Furthermore, in the specification, a numerical range denoted by using “to” indicates a range including numerical values before and after “to” as the lower limit and the upper limit. In addition, in the specification, the term (meth)acrylate means one or both of acrylate and methacrylate.

[Polymer]

A polymer of the present invention is obtained by polymerizing a monomer having two or more radical polymerizable double bonds and one or more hydroxyl groups.

It is preferable that such a monomer is represented by the following Formula X.

Z^{X1}-L^{X1}-L^{X2}-ML^{X3}-L^{X4}-Z^{X2})ₙ Formula X

In Formula X, Z^{X1} and Z^{X2} each independently represent a group having a radical polymerizable double bond, L^{X1} and L^{X4} each independently represent a single bond or an alkylene group having a hydroxyl group, L^{X2} and L^{X3} each independently represent a single bond or a divalent linking group including at least one selected from the group consisting of —O—, —(C═O)O—, —O(C═O)—, a divalent chained group, an alkylene group having a hydroxyl group, and a divalent cyclic aliphatic group, M represents a single bond or a divalent to tetravalent linking group, and n represents an integer of 1 to 3.

Z^{X1} and Z^{X2} each independently represent a group having a radical polymerizable double bond. Examples of the group having a radical polymerizable double bond will be shown below.

Examples of the group having a radical polymerizable double bond include groups represented by the following Formulae Z1 to Z6.

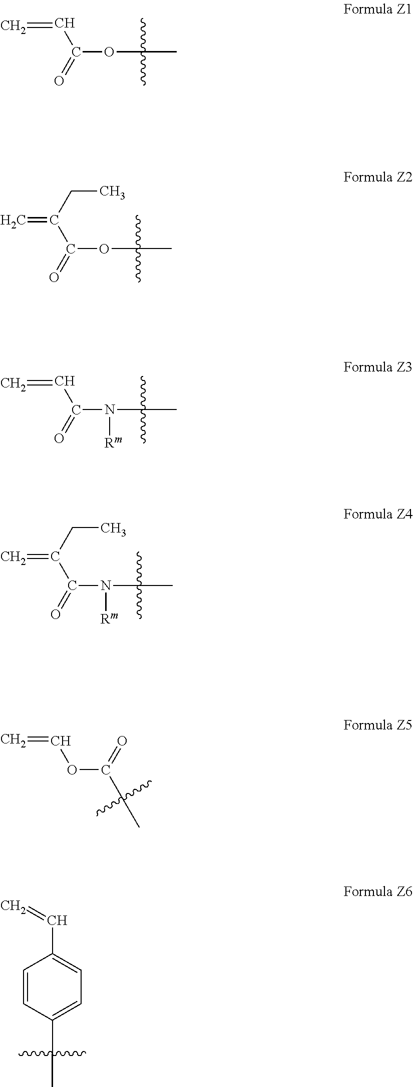

In Formulae Z1 to Z6, R^{m} represents a hydrogen atom or an alkyl group having 1 to 20 carbon atoms, and an alkyl group having 1 to 7 carbon atoms is more preferable and a hydrogen atom or a methyl group is most preferable.

In the above Formulae Z2 to Z6, Formula Z1 or Z2 is preferable and Formula Z is more preferable.

Since the polymer of the present invention has a number of branched structures in a molecule, the entanglement between the molecular chains of the polymer is small and the solubility into various solvents and the compatibility with a matrix resin are high. Therefore, when a composition including the polymer of the present invention is used, a coating film having excellent surface properties can be formed.

L^{x1} and L^{x4} each independently represent a single bond or an alkylene group having a hydroxyl group. L^{x1} and L^{x4} each preferably independently represent —CH₂CH(OH)CH₂— or —CH₂CH(CH₂OH)— and each most preferably independently represent —CH₂CH(OH)CH₂—. L^{x1} and L^{x4} may be the same or different from each other.

L^{X2} and L^{X3} each independently represent a single bond, —O—, —(C═O)O—, —O(C═O)—, a divalent chained group, an alkylene group having a hydroxyl group, or divalent cyclic aliphatic group, or a combination thereof. The divalent chained group may be linear or branched. The alkylene group having a hydroxyl group is preferably —CH₂CH(OH)CH₂— or —CH₂CH(CH₂OH)— and more preferably —CH₂CH(OH)CH₂—.

Preferable examples of combinations of each of L^{X2} and L^{X3} will be shown below.

Preferable combinations of L^{X2} will be shown below. The left side is bonded to the Z^{x1} side and the right side is bonded to M.
Lx21: —O-divalent chained group-
Lx22: —O-divalent cyclic aliphatic group-divalent chained group-
Lx23: —OC(═O)-divalent cyclic aliphatic group-
Lx24: -divalent cyclic aliphatic group-(C═O)O—
Lx25: —(O-divalent chained group)ₙ-
Lx26: —O-alkylene group having a hydroxyl group-

Preferable combinations of L^{X3} will be shown below. The left side is bonded to M and the right side is bonded to the Z^{x2} side.
Lx31: -divalent chained group-O—
Lx32: -divalent chained group-divalent cyclic aliphatic group-O—
Lx33: -divalent cyclic aliphatic group-C(═O)O—
Lx34: —O(C═O)-divalent cyclic aliphatic group-
Lx35: -(divalent chained group-O—)ₙ-
Lx36: -alkylene group having a hydroxyl group-O—

The divalent chained group means an alkylene group, a substituted alkylene group, an alkenylene group, a substituted alkenylene group, an alkynylene group, or a substituted alkynylene group. The divalent chained group is preferably an alkylene group, a substituted alkylene group, an alkenylene group, or a substituted alkenylene group, and more preferably an alkylene group or an alkenylene group.

The alkylene group may have a branch. The number of carbon atoms of the alkylene group is preferably 1 to 12, more preferably 2 to 10, and most preferably 2 to 8.

The alkylene moiety of the substituted alkylene group is the same as the above-described alkylene group. Examples of the substituent include a halogen atom.

The alkenylene group may have a branch. The number of carbon atoms of the alkenylene group is preferably 2 to 12, more preferably 2 to 10, and most preferably 2 to 8.

The alkenylene moiety of the substituted alkenylene group is the same as the above-described alkenylene group. Examples of the substituent include a halogen atom.

The alkynylene group may have a branch. The number of carbon atoms of the alkynylene group is preferably 2 to 12, more preferably 2 to 10, and most preferably 2 to 8.

The alkynylene moiety of the substituted alkynylene group is the same as the above-described alkynylene group. Examples of the substituent include a halogen atom.

Specific examples of the divalent chained group include ethylene, trimethylene, propylene, tetramethylene, 2-methyl-tetramethylene, pentamethylene, hexamethylene, octamethylene, 2-butenylene and 2-butynylene.

The divalent cyclic aliphatic group in Formula X is preferably a 5-, 6- or 7-membered ring, more preferably a 5- or 6-membered ring, and most preferably a 6-membered ring.

The ring included in the divalent cyclic aliphatic group may be any of an aliphatic ring and a saturated heterocyclic ring. Examples of the aliphatic ring include a cyclohexane ring, a cyclopentane ring, and a norbornene ring.

The divalent cyclic aliphatic group may have a substituent. Examples of the substituent include a halogen atom, a cyano group, a nitro group, an alkyl group having 1 to 5 carbon atoms, a halogen substituted alkyl group having 1 to 5 carbon atoms, an alkoxy group having 1 to 5 carbon atoms, an alkylthio group having 1 to 5 carbon atoms, an acyloxy group having 2 to 6 carbon atoms, an alkoxycarbonyl group having 2 to 6 carbon atoms, a carbamoyl group, an alkyl substituted carbamoyl group having 2 to 6 carbon atoms, and an acylamino group having 2 to 6 carbon atoms. Among these, an alkyl group having 1 to 5 carbon atoms and a halogen substituted alkyl group having 1 to 5 carbon atoms are preferable.

In Formula X, n represents an integer of 1 to 3. In the case in which n is 2 or 3, a plurality of L^{X3}'s and L^{X4}'s may be the same or different from each other. A plurality of Z^{x2}'s also may be the same or different from each other. n is preferably 1 or 2 and more preferably 1.

In Formula X, M is a single bond or a divalent to tetravalent linking group. In Formula X, when n is 1, M is a divalent linking group, when n is 2, M is a trivalent linking group, and when n is 3, M is a tetravalent linking group.

M is preferably a divalent to tetravalent chained group, a group having a cyclic aliphatic group, or a group having an aromatic group. As the divalent to tetravalent chained group, a saturated hydrocarbon group having 2 to 4 bonds may be exemplified. The number of carbon atoms of the saturated hydrocarbon group is preferably 1 to 40, more preferably 1 to 20, and still more preferably 1 to 10. The saturated hydrocarbon group may be linear or may have a branch.

Examples of the cyclic aliphatic group include a cyclohexane ring, a cyclopentane ring, and a norbornene ring.

Examples of the group having an aromatic cyclic group include a phenyl group and a naphthalene group.

The monomer represented by Formula X is more preferably a monomer represented by the following Formula X1.

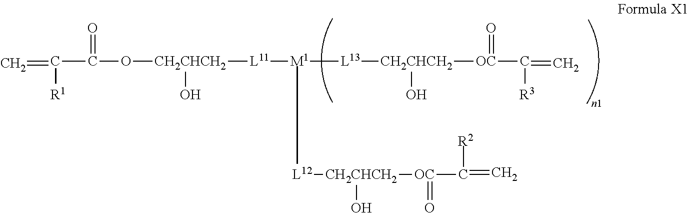

In Formula X1, R¹, R², and R³ each independently represent a hydrogen atom or an alkyl group having 1 to 20 carbon atoms, L¹¹, L¹², and L¹³ each independently represent a single bond or a divalent linking group including at least one selected from the group consisting of —O—, —(C═O)O—, —O(C═O)—, a divalent chained group, an alkylene group having a hydroxyl group, and a divalent cyclic aliphatic group, M¹ represents a single bond or a divalent or trivalent linking group, and n1 represents an integer of 0 to 2.

R¹, R², and R³ each are preferably a hydrogen atom or an alkyl group having 1 to 12 carbon atoms, more preferably an alkyl group having 1 to 6 carbon atoms, and most preferably a hydrogen atom or a methyl group.

L¹¹, L¹², and L¹³ is the same as L^{x2} and L^{x3} in Formula X and the preferable combinations thereof are the same as those of L^{x2} and L^{x3} in Formula X.

In the case in which M is a divalent linking group, the monomer is preferably a monomer represented by the following Formula X2.

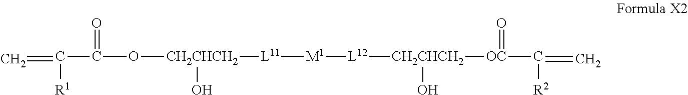

R¹ and R² each are preferably a hydrogen atom or a methyl group and most preferably a hydrogen atom.

L¹¹ and L¹² each are preferably *—O—**, *—O—CH₂—**, *—OCH(CH₃)—**, *—O—C₂H₄—**, *—O—C₃H₆—**, or *—OCH₂CH(OH)CH₂—** and more preferably *—O—CH₂—**. * is bonded to the alkyl group side having a hydroxyl group in Formula X2 and ** is bonded to M¹.

M¹ is preferably a single bond, —C₆H₁₀—, —O(C═O)C₆H₄(C═O)O—, —O(C═O)C₆H₁₀(C═O)O—, or —O—C₆H₄—C(CH₃)(CH₃)—C₆H₄—O—.

The polymer of the present invention may have a partial structure formed by polymerizing a compound having a fluorine atom. The partial structure formed by polymerizing a compound having a fluorine atom is preferably a structure obtained by radically polymerizing a compound having a fluorine atom represented by Formula a.

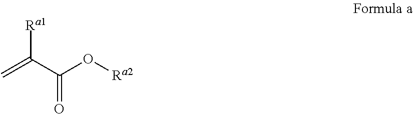

In Formula a, R^{a1} represents a hydrogen atom or an alkyl group having 1 to 20 carbon atoms, and R^{a2} represents an alkyl group having 1 to 20 carbon atoms of which at least one carbon atom has a fluorine atom as a substituent or an alkenyl group having 2 to 20 carbon atoms.

From the viewpoint of increasing the effects of the present invention by reducing the surface energy of the composition of the present invention, in Formula a, R^{a2} is preferably an alkyl group having 1 to 10 carbon atoms of which at least one carbon atom has a fluorine atom as a substituent or an alkenyl group having 2 to 10 carbon atoms, more preferably an alkyl group having 1 to 10 carbon atoms, and a half or more of carbon atoms included in R^{a2} are particularly preferably have a fluorine atom as a substituent.

The partial structure formed by polymerizing a compound having a fluorine atom is more preferably a structure obtained by polymerizing a compound represented by Formula b.

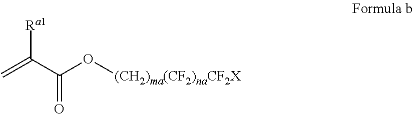

In Formula b, R^{a1} represents a hydrogen atom or an alkyl group having 1 to 20 carbon atoms, ma and na each represent an integer of 0 or greater, and X represents a hydrogen atom or a fluorine atom. ma is preferably an integer of 1 to 10 and na is preferably 4 to 12.

For example, 2,2,2-trifluoroethyl (meth)acrylate, 2,2,3,3,3-pentafluoropropyl (meth)acrylate, 2-(perfluorobutyl)ethyl (meth)acrylate, 2-(perfluorohexyl)ethyl (meth)acrylate, 2-(perfluorooctyl)ethyl (meth)acrylate, 2-(perfluorodecyl)ethyl (meth)acrylate, 2-(perfluoro-3-methylbutyl)ethyl (meth)acrylate, 2-(perfluoro-5-methylhexyl)ethyl (meth)acrylate, 2-(perfluoro-7-methyloctyl)ethyl (meth)acrylate, 1H,1H,3H-tetrafluoropropyl (meth)acrylate, 1H,1H,5H-octafluoropentyl (meth)acrylate, 1H,1H,7H-dodecafluoroheptyl (meth)acrylate, 1H, 1H,9H-hexadecafluorononyl (meth)acrylate, 1H-1-(trifluoromethyl)trifluoroethyl (meth)acrylate, 1H, 1H,3H-hexafluorobutyl (meth)acrylate, 3-perfluorobutyl-2-hydroxypropyl (meth)acrylate, 3-perfluorohexyl-2-hydroxypropyl (meth)acrylate, 3-perfluorooctyl-2-hydroxypropyl (meth)acrylate, 3-(perfluoro-3-methylbutyl)-2-hydroxypropyl (meth)acrylate, 3-(perfluoro-5-methylhexyl)-2-hydroxypropyl (meth)acrylate, and 3-(perfluoro-7-methyloctyl)-2-hydroxypropyl (meth)acrylate may be used.

The polymer of the present invention may be a polymer obtained by co-polymerizing the compound having a fluorine atom. In the polymer of the present invention, from the viewpoint of reactivity and surface modification effect, a ratio of copolymerization of the compound having a fluorine atom is preferably 0.01 to 100 mol, more preferably 0.1 to 50 mol, and most preferably 0.5 to 30 mol with respect to 1 mol of the monomer having two or more radical polymerizable double bonds and one or more hydroxyl groups.

The polymer of the present invention may have a partial structure derived from a compound having a siloxane bond. The structure derived from a compound having a siloxane bond may have a repeating unit represented by —Si(R^{a3})(R^{a4})O— and may constitute at least a part of the molecule. The polymer of the present invention is preferably a graft copolymer in which a polysiloxane structure is introduced into the side chain of the polymer. In the compound having a siloxane bond, R^{a2} in the above Formula a preferably includes —Si(R^{a3})(R^{a4})O—, and the compound more preferably has a structure obtained by polymerizing a compound represented by the following Formula c.

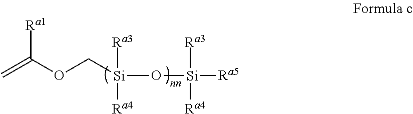

R^{a3} and R^{a4} each represent an alkyl group, a haloalkyl group, or an aryl group. As the alkyl group, an alkyl group having 1 to 10 carbon atoms is preferable. Examples thereof include a methyl group, an ethyl group, and a hexyl group. As the haloalkyl group, a fluorinated alkyl group having 1 to 10 carbon atoms is preferable. Examples thereof include a trifluoromethyl group, and a pentafluoroethyl group. An aryl group having 6 to 20 carbon atoms is preferable. Examples thereof include a phenyl group and a naphthyl group. Among these, R^{a3} and R^{a4} each are preferably a methyl group, a trifluoromethyl group, or a phenyl group, and particularly preferably a methyl group.

R^{a1} is the same as R^{a1} in Formula a and the preferable range thereof is the same as that of R^{a1} in Formula a. R^{a5} is preferably an alkyl group having 1 to 12 carbon atoms and more preferably an alkyl group having 1 to 4 carbon atoms.

nn is preferably 10 to 1,000, more preferably 20 to 500, and still more preferably 30 to 200. The above repeating unit may be constituted of a single monomer or a plurality of monomers.

As the compound having a siloxane bond for graft copolymerization, a polysiloxane macromonomer containing a (meth)acryloyl group at one terminal (for example, SILAPLANE 0721, and SILAPLANE 0725 (all product names, manufactured by Chisso Corporation), AK-5, AK-30, and AK-32 (all product names, manufactured by TOAGOSEI CO., LTD.), and KF-100T, X-22-169AS, KF-102, X-22-3701IE, X-22-164B, X-22-164C, X-22-5002, X-22-173B, X-22-174D, X-22-167B, and X-22-161AS (all product names, manufactured by Shin-Etsu Chemical Co., Ltd.)) may be exemplified.

In the polymer of the present invention, from the viewpoint of reactivity and surface modification effect, a ratio of copolymerization of the compound having a siloxane bond is preferably 0.1 to 50 mol and particularly preferably 0.1 to 30 mol with respect to 1 mol of the monomer having two or more polymerizable groups and one or more hydroxyl groups.

A polymerization initiator is preferably 1 to 15 mol equivalent, more preferably 1 to 10 mol equivalent, and most preferably 2.0 to 10 mol equivalent with respect to 1 mol of the monomer having two or more radical polymerizable double bonds and one or more hydroxyl groups.

Hereinafter, examples of the compound represented by Formula X will be shown. The present invention is not limited to these examples.

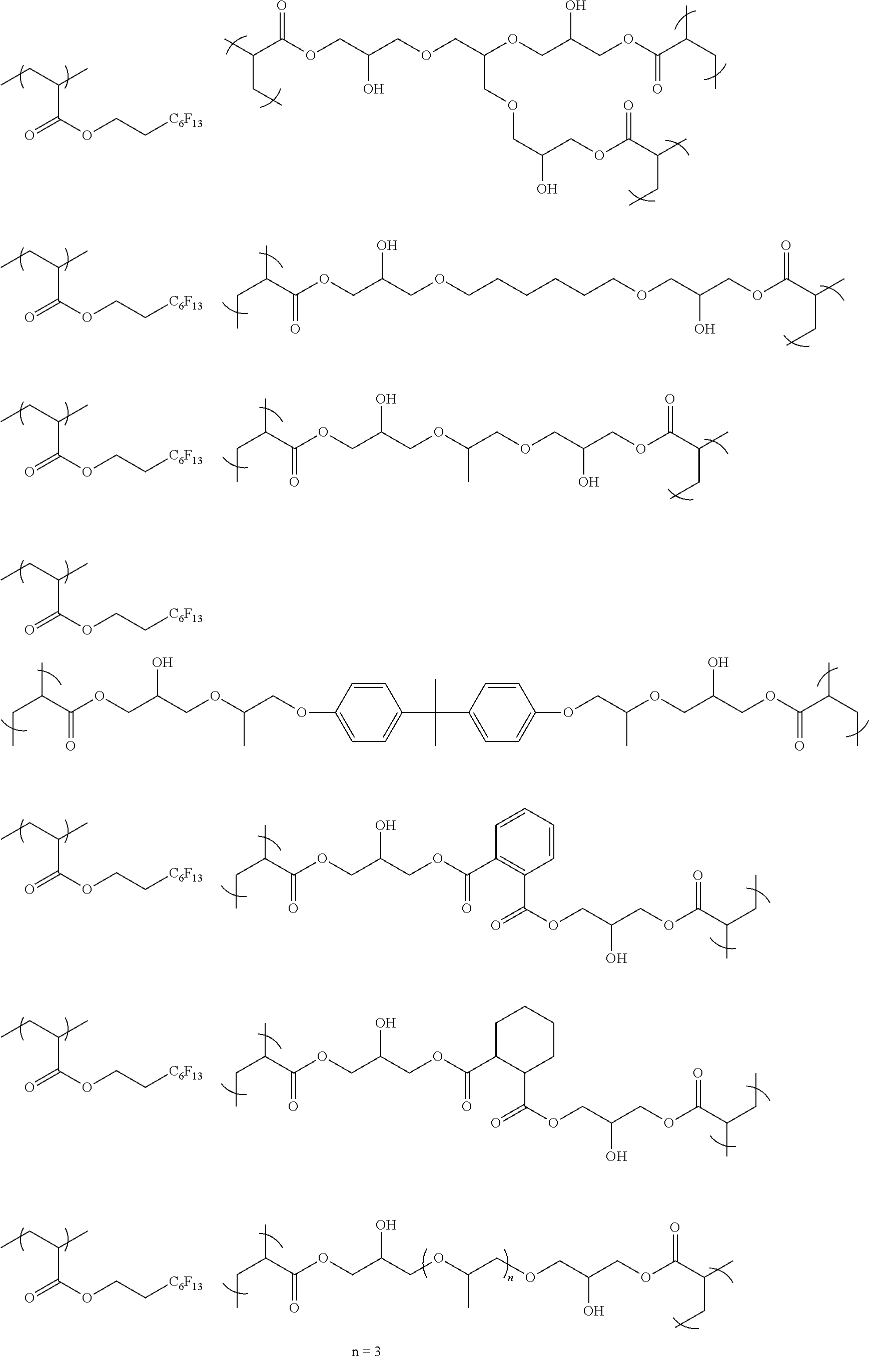

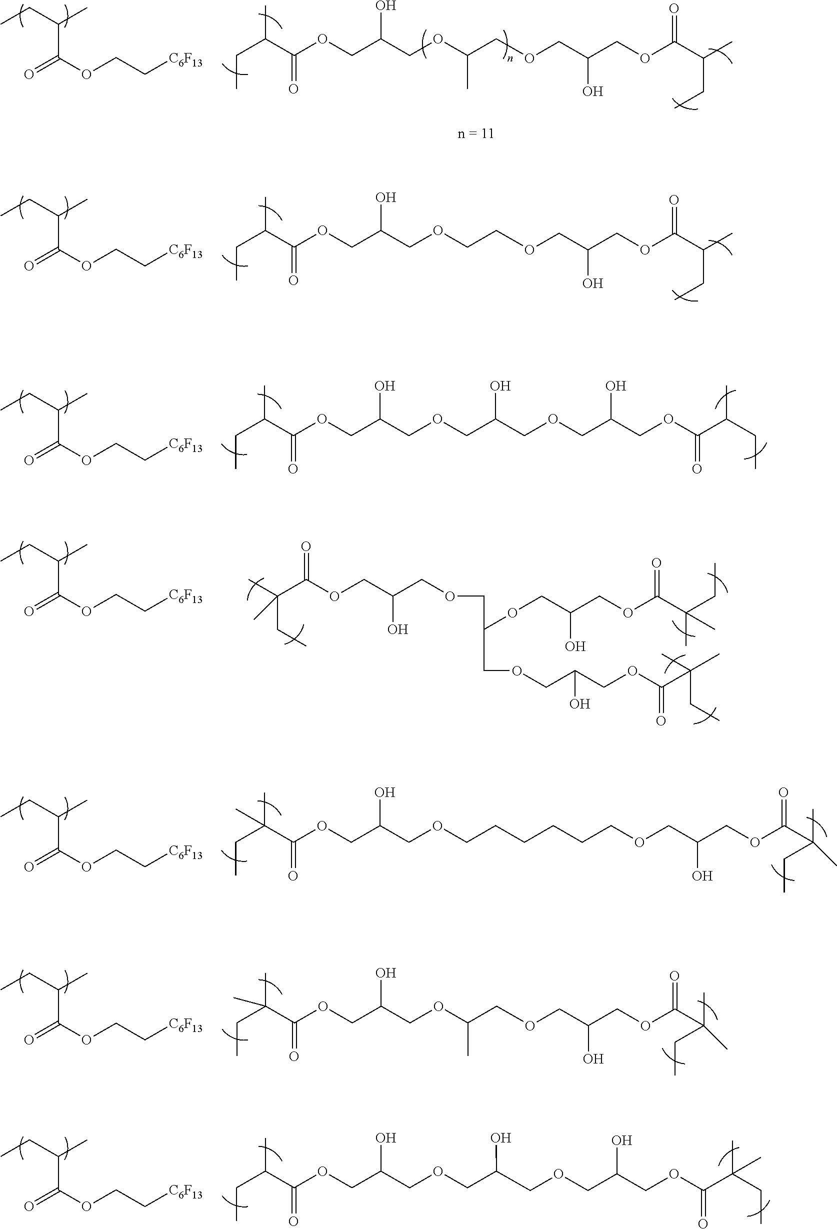

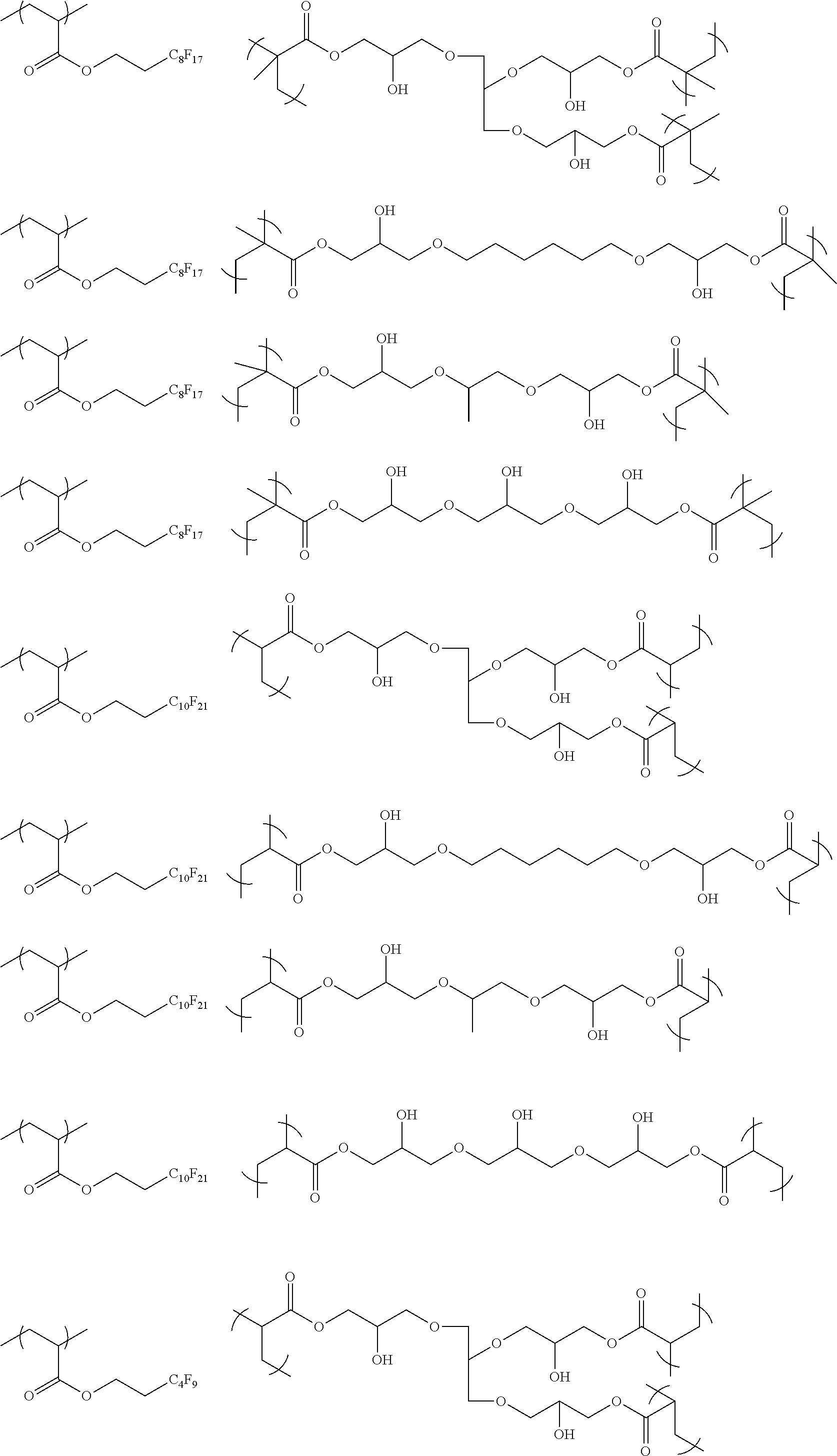

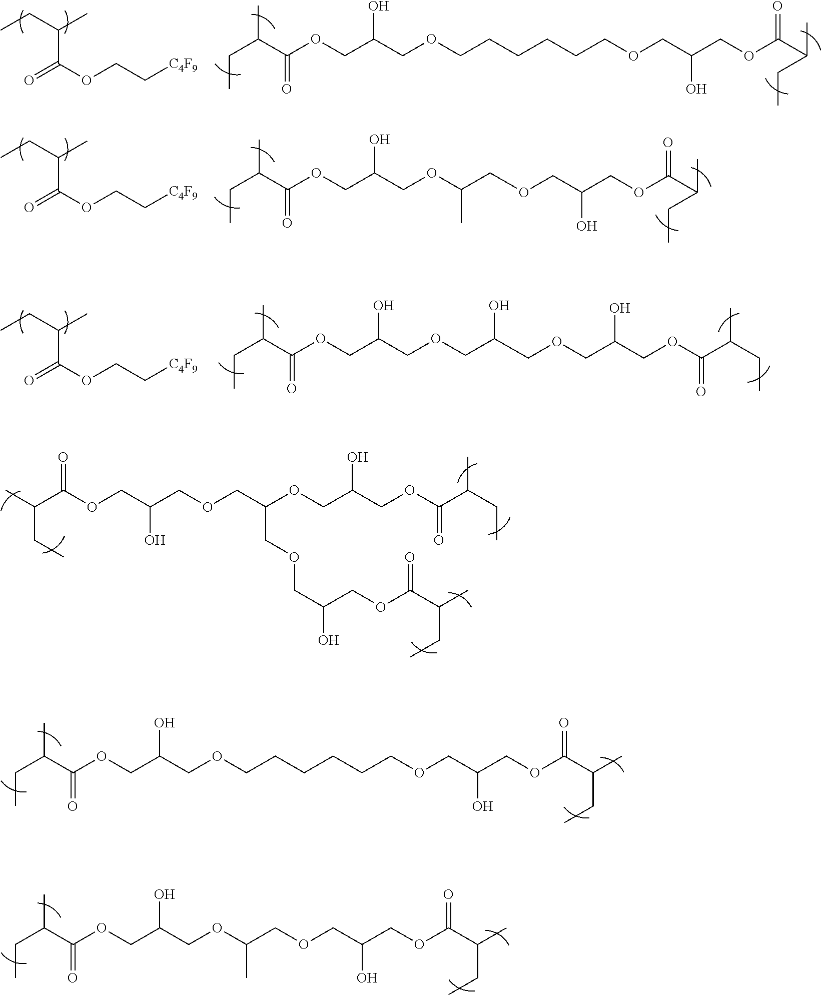

[Composition]

A composition of the present invention includes the polymer of the present invention. The composition of the present invention may further include a liquid crystal compound. The liquid crystal compound may be a polymerizable liquid crystal compound. The polymerizable liquid crystal compound is preferably at least one of a polymerizable rod-like liquid crystal compound or a polymerizable disk-like liquid crystal compound.

The composition of the present invention can be used in the case of forming an optically anisotropic layer, a liquid crystal layer, a phase difference plate, an optical film, an optical compensation film, and the like containing a liquid crystal compound by application.

Herein, the liquid crystal layer includes a layer containing a liquid crystal compound and a polymerizable compound, a layer formed by curing a composition containing a liquid crystal compound and a polymerizable compound, a layer including a polymerizable liquid crystal compound, and a layer formed by curing a polymerizable liquid crystal compound, and all of these layers are mentioned as “liquid crystal layer” below.

(Solvent)

It is preferable that the composition of the present invention includes a solvent. The solvent may be a low surface tension solvent or a standard surface tension solvent. It is preferable that the composition for forming a liquid crystal layer contains a low surface tension solvent.

The surface tension of the low surface tension solvent is 10 to 22 mN/m (10 to 22 dyn/cm), preferably 15 to 21 mN/m, and more preferably 18 to 20 mN/m. The surface tension of the standard surface tension solvent is greater than 22 mN/m, preferably 23 to 50 mN/m, and more preferably 23 to 40 mN/m.

In addition, a difference between the surface tension of the low surface tension solvent and the surface tension of the standard surface tension solvent is preferably 2 mN/m or greater, more preferably 3 mN/m or greater, still more preferably 4 to 20 mN/m, and particularly preferably 5 to 15 mN/m.

In the specification, the surface tension of the solvent is a value described in Solvent Handbook (published by Kodansha Ltd., 1976). For example, the surface tension of the solvent is a physical value that can be measured with an automatic surface tensiometer CBVP-A3 manufactured by Kyowa Interface Science, Co., Ltd. The measurement may be carried out at a condition of 25° C.

As the solvent, organic solvents are preferably used, and among these solvents, a low surface tension solvent and a standard surface tension solvent can be selected. Examples of the organic solvents include alcohols (for example, ethanol, and tert-butyl alcohol), amides (for example, N,N-dimethylformamide), sulfoxides (for example, dimethylsulfoxide), heterocyclic compounds (for example, pyridine), hydrocarbons (for example, heptane, cyclopentane, benzene, hexane, and tetrafluoroethylene), alkyl halides (for example, chloroform, and dichloromethane), esters (for example, methyl acetate, butyl acetate, and isopropyl acetate), ketones (for example, acetone, methyl ethyl ketone, and cyclohexanone), ethers (for example, tetrahydrofuran, and 1,2-dimethoxyethane), and amines (for example, triethylamine). Two or more solvents may be used in combination.

Examples of the low surface tension solvent include tert-butyl alcohol (19.5 mN/m), tetrafluoroethylene (TFE, 20.6 mN/m), triethylamine (20.7 mN/m), cyclopentane (21.8 mN/m), heptane (19.6 mN/m), and a mixed solvent obtained by combining any two or more of these solvents. The numerical value indicates the surface tension. Among these, from the viewpoint of safety, tert-butylalcohol, tetrafluoroethylene, triethylamine, or cyclopentane is preferable, tert-butylalcohol or tetrafluoroethylene is more preferable, and tert-butylalcohol is still more preferable.

Examples of the standard surface tension solvent include methyl ethyl ketone (MEK, 23.9 mN/m), methyl acetate (24.8 mN/m), methyl isobutyl ketone (MIBK, 25.4 mN/m), cyclohexanone (34.5 mN/m), acetone (23.7 mN/m), isopropyl acetate (22.1 mN/m), and a mixed solvent obtained by combining any two or more of these solvents. The numerical value indicates the surface tension. Among these, a mixed solvent of methyl ethyl ketone, cyclohexanone, and another solvent, a mixed solvent of methyl acetate and methyl isobutyl ketone, or the like is preferable.

<Composition for Preparing Liquid Crystal Layer>

The polymer of the present invention can be used for a composition for preparing a liquid crystal layer. The composition for preparing a liquid crystal layer is a composition including the polymer of the present invention, and a liquid crystal compound, preferably a polymerizable liquid crystal compound.

The composition for preparing a liquid crystal layer which hardly causes cissing at application is provided by using the polymer of the present invention. Further, when a liquid crystal layer formed of such a composition for preparing a liquid crystal layer is used as an underlayer and an upper layer is formed on the surface thereof by application, it is possible to provide a composition for preparing a liquid crystal layer which hardly causes cissing at the time of application of a coating solution for forming an upper layer. When the composition for preparing a liquid crystal layer of the present invention is used, it is possible to produce an optical film having a liquid crystal layer which hardly causes cissing at the time of application of the coating solution for forming an upper layer. Therefore, it is possible to produce laminated films having various functions by using the composition for preparing a liquid crystal layer of the present invention. Examples of such laminated film include an optically anisotropic layer, a phase difference plate, an optical film, and an optical compensation film.

The composition for preparing a liquid crystal layer obtained by using the polymer of the present invention includes a hydroxyl group. The hydroxyl group used in the composition for preparing a liquid crystal layer is preferably 0.0001% by mass to 10% by mass with respect to the liquid crystal compound.

The present inventors have found that the composition including a hydroxyl group at a predetermined ratio as described above which hardly causes cissing at the time of application and capable of forming a liquid crystal layer having a uniform film surface without unevenness can be produced. Particularly, it has been found that cissing at the time of upper layer formation, which is a problem arising in the production of the laminated film, can be also suppressed. Although the mechanism is not clear, it is presumed as follows. That is, since the polarity of the upper layer is close to the polarity of the base material, particularly, the liquid crystal layer of the underlayer, at the time of application and the composition is easily wet and spreads, cissing can be prevented from occurring.

Further, when a copolymer with a fluorine monomer including the polymer of the present invention is formed, the surface transferability is improved and the surface tension of the coating solution is lowered. Thus, a surface condition smoothing (leveling) function is exhibited. In addition, it is considered that the resistance of the peripheral environment against wind can be improved to hardly cause optical unevenness and further cissing can be suppressed.

The composition for preparing a liquid crystal layer containing the polymer of the present invention may include the above solvent. The concentration of the solvent with respect to the total mass of the composition for preparing a liquid crystal layer is preferably 95% to 50% by mass, more preferably 93% to 60% by mass, and still more preferably 90% to 75% by mass.

In a drying step when the liquid crystal layer is formed, preferably, 95% by mass or more of the solvent of the composition for preparing a liquid crystal layer with respect to the total amount of the solvent is removed, more preferably, 98% by mass or more of the solvent of the composition for preparing a liquid crystal layer with respect to the total amount of the solvent is removed, still more preferably, 99% by mass or more of the solvent of the composition for preparing a liquid crystal layer with respect to the total amount of the solvent is removed, and particularly preferably, substantially 100% by mass of the solvent of the composition for preparing a liquid crystal layer is removed.

(Liquid Crystal Compound)

As the liquid crystal compound, a rod-like liquid crystal compound and a disk-like liquid crystal compound can be used. In the liquid crystal compound, a low molecular liquid crystal compound is included. In the present invention, the term “low molecular” refers to a degree of polymerization of less than 100. In addition, the liquid crystal compound includes a rod-like liquid crystal compound and a disk-like liquid crystal compound.

(Polymerizable Liquid Crystal Compound)

The polymerizable liquid crystal compound refers to a liquid crystal compound having a polymerizable group. Examples of the polymerizable group include an acryloyl group, a methacryloyl group, an epoxy group, and a vinyl group. The alignment of a liquid crystal compound can be fixed by curing the polymerizable liquid crystal compound and the polymerizable liquid crystal compound can be used for an optical compensation film or the like.

As the rod-like liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans and alkenylcyclohexyl benzonitriles are preferably used.

As the rod-like liquid crystal compound which is a polymerizable liquid crystal compound, compounds described in Makromol. Chem., vol. 190, page 2255 (1989), Advanced Materials vol. 5, p. 107 (1993), U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), and JP2001-64627 can be used. Further, as the rod-like liquid crystal compound, for example, compounds described in JP1999-513019A (JP-H11-513019A) and JP2007-279688A can be preferably used.

Examples of the disk-like liquid crystal compound include compounds described in JP2007-108732A and JP2010-244038A.

(Polymerization Initiator)

In the case in which the composition is cured by polymerizing the polymerizable compound to form a liquid crystal layer or the lie, the liquid crystal component may include a polymerization initiator.

Examples of the polymerization initiator include ca-carbonyl compounds (described in each of U.S. Pat. No. 2,367,661A and U.S. Pat. No. 2,367,670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in each of U.S. Pat. No. 3,046,127A and U.S. Pat. No. 2,951,758A), combinations of triarylimidazole dimer and p-aminophenyl ketone (described in U.S. Pat. No. 3,549,367A), acrydine and phenazine compounds (described in JP1985-105667A (JP-S60-105667A), and U.S. Pat. No. 4,239,850A), oxadiazole compounds (described in U.S. Pat. No. 4,212,970A), and acylphosphine oxide compounds (described in JP1988-40799B (JP-S63-40799B), JP1993-29234B (JP-H05-29234B), JP1998-95788A (JP-H10-95788A), and JP1998-29997A (JP-H10-29997A)).

(Chiral Agent)

The liquid crystal layer formed of the composition for preparing a liquid crystal layer may be a layer formed by fixing a cholesteric liquid crystalline phase. In this case, the composition preferably includes a chiral agent.

The chiral agent can be selected from various known chiral agents (for example, described in Liquid Crystal Device Handbook, Third Chapter, 4-3 Chapter, chiral agents used for TN and STN, page 199, edited by No. 142 Committee of Japan Society for the Promotion of Science, 1989). The chiral agent generally includes an asymmetric carbon atom but an axially asymmetric compound not including an asymmetric carbon atom or a planar asymmetric compound can be used as a chiral agent. Examples of the axially asymmetric compound or the planar asymmetric compound include binaphthyl, helicene, paracyclophane, and derivatives thereof. The chiral agent may have a polymerizable group. In the case in which the chiral agent has a polymerizable group and the rod-like liquid crystal compound to be used in combination also has a polymerizable group, a polymer having a repeating unit derived from the rod-like liquid crystal compound and a repeating unit derived from the chiral agent can be formed by a polymerization reaction of the chiral agent having a polymerizable group and the polymerizable rod-like liquid crystal compound. In this embodiment, it is preferable that the polymerizable group of the chiral agent having the polymerizable group is the same as the polymerizable group of the polymerizable rod-like liquid crystal compound. Accordingly, the polymerizable group of the chiral agent is also preferably an unsaturated polymerizable group, an epoxy group, or an aziridinyl group, more preferably an unsaturated polymerizable group, and particularly preferably an ethylenically unsaturated polymerizable group.

In addition, the chiral agent may be a liquid crystal compound.

Examples of a chiral agent exhibiting a strong twisting force that can be preferably used include chiral agents described in JP2010-181852A, JP2003-287623A, JP2002-80851A, JP2002-80478A, and JP2002-302487A. Further, regarding isosorbide compounds described in these known publications, isosorbide compounds having corresponding structures can be used and regarding isomannide compounds described in these known publications, isomannide compounds having corresponding structures can be used.

(Fluorine-Based Surfactant and Silicone-Based Surfactant)

The composition of the present invention may include the fluorine-based surfactant and the silicone-based surfactant. The content of the fluorine-based surfactant and the silicone-based surfactant in the composition for preparing a liquid crystal layer is preferably 5% by mass or less with respect to the total mass of the composition.

The fluorine-based surfactant is a compound which includes fluorine and is unevenly distributed on the surface in the solvent to be used in the composition for preparing a liquid crystal layer. Examples of a fluorine-based surfactant having a hydrophobic moiety include compound containing fluorine among compounds described in paragraphs 0028 to 0034 of JP2011-191582A as an orientation suppressing agent and fluorine-based surfactants described in JP2841611B, and fluorine-based surfactants described in paragraphs 0017 to 0019 of JP2005-272560A.

Examples of a commercially available fluorine-based surfactant include SURFLON (registered trademark) manufactured by AGC SEIMI CHEMICAL CO., LTD. and MEGAFAC (registered trademark) manufactured by DIC Corporation.

The silicone-based surfactant is a compound which includes silicone and is unevenly distributed on the surface in the solvent to be used in the composition for preparing a liquid crystal layer.

Examples of the silicone-based surfactant include low molecular compounds containing a silicon atom such as polymethylphenylsiloxane, polyether-modified silicone oil, polyether-modified dimethylpolysiloxane, dimethyl silicone, diphenyl silicone, hydrogen-modified polysiloxane, vinyl-modified polysiloxane, hydroxyl-modified polysiloxane, amino-modified polysiloxane, carboxyl-modified polysiloxane, chloro-modified polysiloxane, epoxy-modified polysiloxane, methacryloxy-modified polysiloxane, mercapto-modified polysiloxane, fluorine-modified polysiloxane, long-chain alkyl-modified polysiloxane, phenyl-modified polysiloxane, and silicone-modified copolymer.

Examples of a commercially available silicone-based surfactant include KF-96 and X-22-945 (all manufactured by Shin-Etsu Chemical Co., Ltd.), TORAY SILICONE DC3PA, TORAY SILICONE DC7PA, TORAY SILICONE SH11PA, TORAY SILICONE SH21PA, TORAY SILICONE SH28PA, TORAY SILICONE SH29PA, TORAY SILICONE SH30PA, and TORAY SILICONE FS-1265-300 (all manufactured by Dow Corning Toray Silicone Co., Ltd.), TSF-4300, TSF-4440, TSF-4445, TSF-4446, TSF-4452, and TSF-4460 (all manufactured by GE Toshiba Silicones Co., Ltd.), polysiloxane polymer KP341 (manufactured by Shin-Etsu Chemical Co., Ltd.), BYK-301, BYK-302, BYK-307, BYK-325, BYK-331, BYK-333, BYK-341, BYK-345, BYK-346, BYK-348, and BYK-375 (all manufactured by BYK-Chemie Japan KK), ARON GS-30 (manufactured by TOAGOSEI CO., LTD.), and SILICONE L-75, Silicone L-76, SILICONE L-77, SILICONE L-78, Silicone L-79, SILICONE L-520, and SILICONE L-530 (all manufactured by Nippon Unicar. Co., Ltd.).

[Optical Film]

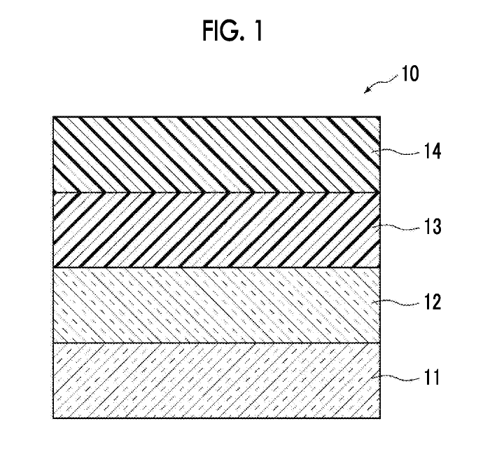

With reference to FIG. 1, an optical film of an embodiment according to the present invention will be described. FIG. 1 is a schematic cross-sectional view of an optical film of an embodiment. In FIG. 1, the scale of each portion is appropriately changed for allowing easy viewing. An optical film 10 includes a λ/4 layer 12, and a liquid crystal layer 13 and a liquid crystal layer 14 adjacent to each other on a support 11, and the liquid crystal layer 13 includes a liquid crystal layer containing a liquid crystal compound and the polymer of the present invention, or a liquid crystal layer formed by curing a composition including a liquid crystal compound and the polymer of the present invention. The optical film may be formed by these liquid crystal layers, may further include a liquid crystal layer, or may include layers other than the liquid crystal layer. Examples of other layers include an alignment layer and a surface protective layer. In addition, the optical film may have liquid crystal layers other than the liquid crystal layer formed of the composition including the polymer of the present invention.

Further, the optical film 10 preferably includes a layer formed by fixing a cholesteric liquid crystalline phase, and the liquid crystal layer 13 is preferably a layer formed by fixing a cholesteric liquid crystalline phase.

As shown in FIG. 1, it is preferable that the optical film 10 has a structure in which the liquid crystal layer close to the support 11 is set to an underlayer (liquid crystal layer 13) and on the surface thereof as an upper layer, and the liquid crystal layer 13 formed by applying a composition including the polymer of the present invention, a liquid crystal component, and a solvent is provided. At this time, the solvent of the composition can be selected from the organic solvents exemplified in the above description. A structure in which a layer is further formed on the surface of the liquid crystal layer 13 in the same manner is preferable and the optical film 10 may be a laminated film of three to ten liquid crystal layers formed in the same manner.

In the optical film 10, it is preferable that any one of the liquid crystal layer 13 and the liquid crystal layer 14 is a layer formed of a composition including a rod-like liquid crystal compound, and the other is a layer formed of a composition including a disk-like liquid crystal compound. Further, it is also preferable that any one of the liquid crystal layer 13 and the liquid crystal layer 14 is a layer formed by curing a composition including a polymerizable rod-like liquid crystal compound, and the other is a layer formed by curing a composition including a polymerizable disk-like liquid crystal compound. It is more preferable that the liquid crystal layer 13 is a layer including a disk-like liquid crystal compound and the liquid crystal layer 14 is a layer including a rod-like liquid crystal compound.

The application of the optical film 10 is not particularly limited. Examples of the optical film include a phase difference film, a reflection film, and a light absorption film. More specific examples thereof include an optical compensation film, a polarizing film, a luminance improving film, a heat blocking film, and a film for projection used for a liquid crystal display device or the like.

The optical film prepared using the polymer of the present invention may be a support film for preparing a laminated film other than the form of the optical film 10 of the embodiment. The support film includes the above underlayer (liquid crystal layer 13). It is preferable that the support film includes the liquid crystal layer 13 as the outermost layer or includes only a film which is easily peelable, such as a laminate film or the like, on the outer side of the liquid crystal layer 13. It is preferable that the liquid crystal layer 13 in the support film is a liquid crystal layer. It is more preferable that the liquid crystal layer 13 in the support film is a layer formed by curing a composition including a polymerizable disk-like liquid crystal compound. The support film may include layers such as a support, an alignment layer, and another liquid crystal layer in addition to the liquid crystal layer 13.

(Support)

As the support 11, glass and a polymer film can be used. Examples of materials for a polymer film used as the support include cellulose acylate film (for example, a cellulose triacetate film (refractive index 1.48), a cellulose diacetate film, a cellulose acetate butyrate film, and a cellulose acetate propionate film), polyolefin such as polyethylene and polypropylene, a polyester-based resin film such as polyethylene terephthalate or polyethylene naphthalate, a polyether sulfone film, a polyacrylate-based resin film such as polymethyl methacrylate, a polyurethane-based resin film, a polyester film, a polycarbonate film, a polysulfone film, a polyether film, a polymethylpentene film, a polyether ketone film, a (meth)acrylonitrile film, polyolefin, and a cycloolefin-based polymer film (for example, product name “ARTON” (registered trademark), manufactured by JSR Corporation, product name “ZEONEX” (registered trademark), manufactured by Zeon Corporation). Among these, triacetyl cellulose, polyethylene terephthalate, and a polymer having an alicyclic structure are preferable and triacetyl cellulose is particularly preferable.

The support may be a temporary support not including the optical film which is peeled off after the liquid crystal layer is formed.

The film thickness of the support may be about 5 μm to 1,000 μm, is preferably 10 μm to 250 μm, and more preferably 15 μm to 90 μm.

(Alignment Layer)

The optical film may include an alignment layer. The alignment layer is used when a layer such as a liquid crystal layer is formed and is used for aligning the molecules of a liquid crystal compound included in the composition for preparing a liquid crystal layer.

The optical film may or may not include the alignment layer.

The alignment layer can be provided by means of a rubbing treatment of an organic compound (preferably a polymer), an oblique vapor deposition of an inorganic compound such as SiO, the formation of a layer having a microgroove, or the like. Further, there is also known an alignment layer in which an orientation function occurs by applying an electric field, applying a magnetic field, or carrying out light irradiation.

Depending on the materials for the underlayer such as the support and the liquid crystal layer, the underlayer can be allowed to function as the alignment layer by carrying out a directly alignment treatment (for example, a rubbing treatment) on the underlayer without providing the alignment layer. Examples of the support which becomes such an underlayer include polyethylene terephtalate (PET).

In addition, in the case in which a layer is directly laminated on the liquid crystal layer, the liquid crystal layer of the underlayer behaviors as the alignment layer and thus the liquid crystal compound for preparing an upper layer can be aligned in some cases. In such a case, the liquid crystal compound of the upper layer can be aligned without providing the alignment layer and carrying out a particular alignment treatment (for example, a rubbing treatment).

Hereinafter, a rubbing-treated alignment layer of which the surface is subjected to a rubbing treatment to be used and a photo alignment layer will be described as preferable examples.

—Rubbing-Treated Alignment Layer—

As examples of the polymer that can be used for the rubbing-treated alignment layer, for example, include methacrylate-based copolymers, styrene-based copolymers, polyolefins, polyvinyl alcohols, modified polyvinyl alcohols, poly(N-methylolacryl amide), polyesters, polyimides, vinyl acetate copolymers, carboxymethyl cellulose, and polycarbonates described in paragraph [0022] of JP1996-338913A (JP-H08-338913A). A silane coupling agent can be used as a polymer. A water-soluble polymer (for example, poly(N-methylolacrylamide), carboxymethyl cellulose, gelatin, polyvinyl alcohol, or modified polyvinyl alcohol) is preferable, gelatin, polyvinyl alcohol, or modified polyvinyl alcohol is more preferable, and polyvinyl alcohol or modified polyvinyl alcohol is most preferable.

The above-described composition is applied to the rubbing-treated surface of the alignment layer and the molecules of the liquid crystal compound are aligned. Thereafter, as necessary, the above-described optically anisotropic layer can be formed by reacting an alignment layer polymer with a polyfunctional monomer included in the optically anisotropic layer or crosslinking an alignment layer polymer using a crosslinking agent.

The film thickness of the alignment layer is preferably within a range of 0.1 to 10 μm.

——Rubbing Treatment——

The surface of the alignment layer, the support, or another layer to which the composition for preparing a liquid crystal layer may be subjected to a rubbing treatment as necessary. The rubbing treatment can be generally carried out by rubbing the surface of the film having a polymer as a main component with paper or cloth in a predetermined direction. A general method of the rubbing treatment is described, for example, in “Liquid Crystal Handbook” (published by MARUZEN CO., LTD., Oct. 30, 2000).

As the method of changing the rubbing density, the method described in “Liquid Crystal Handbook” (published by MARUZEN CO., LTD.) can be used. The rubbing density L is quantified by the following Equation A.

L=N1(1+2πrn/60v) Equation A

In equation A, N is the number of rubbing, 1 is the contact length of a rubbing roller, r is the radius of a roller, n is a rotation speed (rpm) of a roller, and v is a stage moving speed (speed per second).

In order increase the rubbing density, the number of rubbing may be increased, the contact length of a rubbing roller may be lengthened, the radius of a roller may be increased, the rotation speed of a roller may be increased, or the stage moving speed may be lowered. On the other hand, in order to decrease the rubbing density, the opposite operation thereof may be carried out. In addition, as the conditions at the time of the rubbing treatment, it is also possible to refer to the description in JP4052558B.

—Photo Alignment Layer—

The photo alignment materials used for the photo alignment layer formed by light irradiation are described in a number of documents. Preferable examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadimide compounds having photo alignment units described in JP2002-265541A and JP2002-317013A, photo-cross-linkable silane derivatives described in JP4205195B and JP4205198B, and photo-cross-linkable polyimides, polyamides, or esters described in JP2003-520878A, JP2004-529220A, and JP4162850B. Azo compounds, photo-cross-linkable polyimides, polyamides or esters are particularly preferable.

The photo alignment layer is produced by irradiating the photo alignment layer formed of the above material with linearly polarized light or unpolarized light.

In the specification, the term “linearly polarized light irradiation” is an operation for causing a photoreaction to the photo alignment material. The wavelength of the light used is not particularly limited as long as the wavelength varies depending on the photo alignment material used and is a wavelength necessary for the photoreaction. The peak wavelength of the light used for light irradiation is preferably 200 nm to 700 nm and ultraviolet light having a light peak wavelength of 400 nm or less is more preferable.

The light source of the light irradiation may be a typically used light source and examples thereof include lamps (for example, a tungsten lamp, a halogen lamp, a xenon lamp, a xenon flash lamp, a mercury lamp, a mercury/xenon lamp, or a carbon arc lamp), various lasers (for example, a semiconductor laser, a helium/neon laser, an argon ion laser, a helium/cadmium laser, or an YAG laser), light emitting diodes, and cathode ray tubes.

As means for obtaining linearly polarized light, a method using a polarizing plate (for example, an iodine polarizing plate, a dichroic dye polarizing plate, or a wire grid polarizing plate), a method using a prism element (for example, a Glan-Thompson prism) or a reflective type polarizer using Brewster's angle, or a method using light emitted from a polarized laser light source may be adopted. Alternatively, light having only a necessary wave length may be selectively employed for irradiation using a filter, a wavelength converter, or the like.

In the case of using linearly polarized light as light for irradiation, a method in which the alignment layer is irradiated with the light from the upper surface or rear surface in a direction perpendicular or oblique to the alignment film surface is adopted. Although the incidence angle of the light varies depending on the photo alignment material, for example, the incidence angle is 0° to 90° and preferably 40° to 90°. In this case, 90° is a perpendicular direction.

In the case of using unpolarized light, the alignment layer is irradiated with unpolarized light from an oblique direction. The incidence angle of the light is 10° to 80°, preferably 20° to 60°, and particularly preferably 30° to 50°.

The irradiation time is preferably 1 minute to 60 minutes, and more preferably 1 minute to 10 minutes.

(Method of Producing Optical Film)

The optical film can be produced by forming the liquid crystal layer on the support. The support may be peeled off after the liquid crystal layer is formed. In the specification, the term “on the support” used therein means “directly on the surface of the support” or “through another layer formed on the surface of the support”. The liquid crystal layer may be formed on the surface of another layer which has been formed in advance.

It is preferable that the liquid crystal layer is further formed on the surface of the liquid crystal layer as described above. The liquid crystal layer formed of the composition for preparing a liquid crystal layer of the present invention hardly causes cissing and thus various lamination type optical films can be prepared. It is particularly preferable that the composition of the present invention is directly applied to the surface of the liquid crystal layer which has been formed in advance. When the composition of the present invention is applied to form a film, cissing hardly occurs, the surface condition is excellent, and further, orientation defects can be reduced.

(Formation of Liquid Crystal Layer)

The liquid crystal layer is formed by a coating film formed of the composition of the present invention. For example, the liquid crystal layer may be a layer formed by applying the composition to the support and drying the obtained coating film and may be a layer formed through a curing step by light irradiation, heating, or the like.

The application of the composition of the present invention can be carried out by a method of deploying the composition by an appropriate method such as a roll coating method, a gravure printing method, or a spin coating method. Further, the composition can be applied by various methods such as a wire bar coating method, an extrusion coating method, a direct gravure coating method, a reverse gravure coating method, and a die-coating method. In addition, it is also possible to form a coating film by jetting the composition from a nozzle using an ink jet device.

Drying may be carried out by leaving or heating the coating film. In a drying step, an optical function derived from the liquid component may be exhibited. For example, in the case in which the liquid crystal component includes a liquid crystal compound, in the process of removing a solvent by drying, a liquid crystal phase may be formed. The formation of the liquid crystal phase may be carried out by heating the coating film to obtain a transition temperature to a liquid crystal phase. For example, by heating to the temperature of the isotropic phase once and then cooling to the liquid crystal phase transition temperature, the liquid crystal composition can be made to be stably in a state of a liquid crystal phase. The liquid crystal phase transition temperature is preferably within a range of 10° C. to 250° C. and more preferably within a range of 10° C. to 150° C. from the viewpoint of production suitability. When the transition temperature is lower than 10° C., a cooling step or the like of lowering the temperature to a temperature range in which a liquid crystal phase is exhibited is required. When the transition temperature is higher than 200° C., a high temperature is required to make be in an isotropic liquid state of a temperature higher than the temperature range in which a liquid crystal phase is exhibited, and also from the viewpoint of waste of heat energy or deformation or deterioration of a substrate, this case is disadvantageous.

For example, in the case in which the composition includes a polymerizable compound, it is preferable that the film after the above drying is cured. In the case in which the composition includes a polymerizable liquid crystal compound, the alignment state of the molecules of the liquid crystal compound can be maintained and fixed by curing. The curing can be carried out by a polymerization reaction of the polymerizable group in the polymerizable compound.

The polymerization reaction includes a thermal polymerization reaction using a thermal polymerization initiator and a photopolymerization reaction using a photopolymerization initiator, and the photopolymerization reaction is preferable. The light irradiation for polymerization of the polymerizable compound, particularly, the polymerizable liquid crystal compound is preferably carried out using ultraviolet rays. The irradiation energy is preferably 50 mJ/cm² to 1,000 J/cm² and more preferably 100 to 800 mJ/cm². In order to accelerate the photopolymerization reaction, light irradiation may be carried out under a heating condition.

In order to accelerate a curing reaction, ultraviolet irradiation may be carried out under a heating condition. In addition, since the oxygen concentration in the atmosphere is involved in the polymerization degree, in a case in which a desired polymerization degree is not achieved in air and the film hardness is not sufficient, by a method of nitrogen substitution or the like, it is preferable to reduce the oxygen concentration in the atmosphere. The oxygen concentration is preferably 10% by volume or less, more preferably 7% by volume or less, and most preferably 3% by volume or less.

The reaction rate of the curing reaction (for example, polymerization reaction) which proceeds by irradiation with ultraviolet rays is preferably 60% or more, more preferably 70% or more, and still more preferably 80% or more, from the viewpoint of keeping mechanical strength of a layer or preventing the unreacted substances from flowing out from a layer. In order to improve the reaction rate, a method of increasing the irradiation amount of ultraviolet rays applied or a polymerization in a nitrogen atmosphere or under a heating condition is effective. In addition, after polymerization, a method of further promoting the reaction by a thermal polymerization reaction by keeping a state of a temperature higher than the polymerization temperature or a method of carrying out irradiation with ultraviolet rays again can also be used. The reaction ratio can be measured by comparing the values of the absorption intensity of the infrared vibrational spectrum of the reactive group (for example, a polymerizable group) before and after the reaction progress.

The optical properties based on the alignment of the liquid crystal compound molecules of the liquid crystal layer using the liquid crystal compound as a liquid crystal component, for example, the optical properties of a cholesteric liquid crystalline phase, are sufficient as long as the optical properties are kept in the layer and it is no longer necessary that the liquid crystal composition of the liquid crystal layer after curing exhibits liquid crystallinity. For example, the liquid crystal composition may lose liquid crystallinity by increasing the molecular weight of the liquid crystal compound molecule by a curing reaction.

The liquid crystal layer is also preferably a cholesteric liquid crystal layer formed by fixing the alignment of a cholesteric liquid crystalline phase. As the cholesteric liquid crystal layer and the method of producing the cholesteric liquid crystal layer, for example, cholesteric liquid crystal layers and methods described in JP1989-133003A (JP-H01-133003A), JP3416302B, JP3363565B, and JP1996-271731A (JP-H08-271731A) can be referred to.

[Liquid Crystal Display Device]

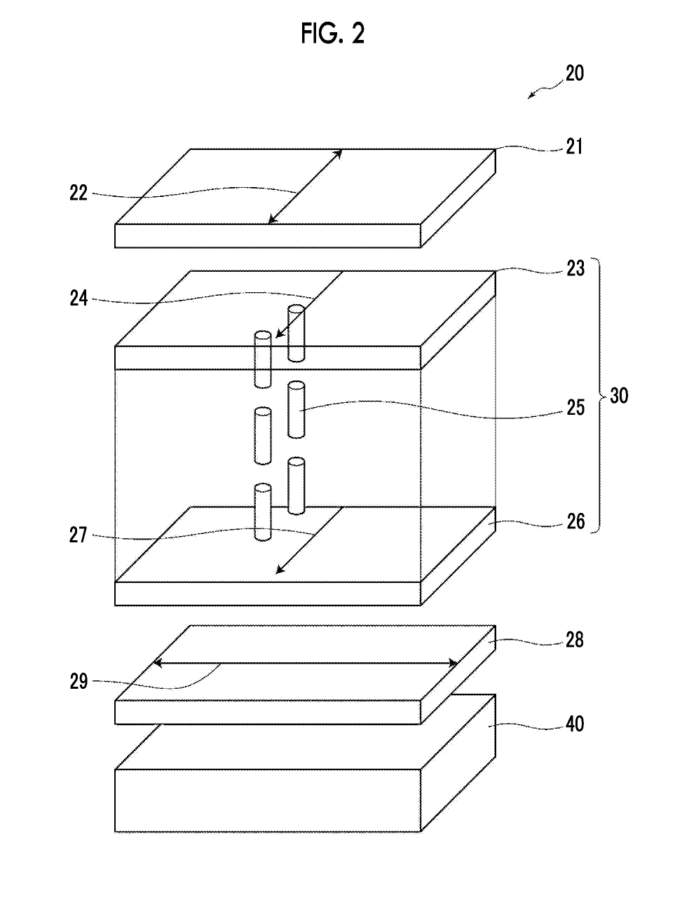

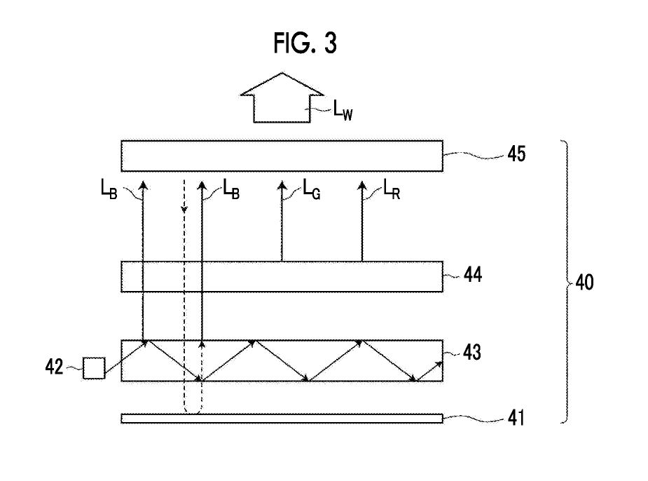

The optical film of the present invention can be used as a luminance improving film used for a backlight of a liquid crystal display device. Hereinafter, a liquid crystal display device of an embodiment of the present invention will be described. FIG. 2 is a schematic view showing the configuration of a liquid crystal display device 20 of an embodiment according to the present invention. FIG. 3 is a schematic cross-sectional view showing a backlight unit.

As shown in FIG. 2, a liquid crystal display device 20 includes a pair of polarizing plates (an upper side polarizing plate 21 and a lower side polarizing plate 28), a liquid crystal cell 30 interposed between the polarizing plates, and a backlight unit 40 disposed on the opposite side of the liquid crystal cell of the lower side polarizing plate 28, and the liquid crystal cell 30 has liquid crystals 25 and a liquid crystal cell upper electrode substrate 23 and a liquid crystal cell lower electrode substrate 26 which are arranged on the upper and lower sides of the liquid crystals. Since the backlight unit 40 includes a polarized light emitting film, the lower side polarizing plate 28 can be omitted.

In the case in which the liquid crystal display device 20 is used as a transmission type, the upper side polarizing plate 21 is set to a front side (viewing side) polarizing plate and the lower side polarizing plate 28 is set to a rear side (backlight side) polarizing plate. Although not shown in the drawing, a color filter is provided between the liquid crystals 25 and the upper side polarizing plate 21. In FIG. 2, the numeral references 22 and 29 indicate directions of absorption axes of each polarizing plate which are substantially mutually orthogonal to each other, and the numeral references 24 and 27 indicate alignment control directions of each electrode substrate.

As shown in FIG. 3, the backlight unit 40 includes a light source 42 which emits primary light (blue light L_{B}), a light guide plate 43 which guides the primary light emitted from the light source 42, a wavelength conversion member 44 which is provided on the light guide plate 43, a luminance improving film 45 which is arranged to face the light source 42 with the wavelength conversion member 44 interposed therebetween, and a reflection plate 41 which is arranged to face the wavelength conversion member 44 with the light guide plate 43 interposed therebetween. The wavelength conversion member 44 emits fluorescent light by using at least a part of the blue light L_{B} emitted from the light source 42 as exciting light, and emits secondary light (L_{G}, L_{R}) formed of the fluorescent light and the primary light L_{B} which has passes through the wavelength conversion member 44. The backlight unit 40 emits white light L_{w} by the secondary light (L_{G}, L_{R}) and the primary light L_{B} which has passes through the wavelength conversion member 44.

The luminance improving film 45 has the optical film 10 of the present invention.

As the light source 42, a light source that emits blue light having a light emission center wavelength in a wavelength range of 430 nm to 480 nm, for example, blue light emitting diode emitting blue light can be used. In the case of using a light source that emits blue light, it is preferable that the wavelength conversion member 44 at least includes a quantum dot R which emits red light excited by exciting light and a quantum dot G which emits green light. Thus, white light can be realized by the blue light emitted from the light source and passing through the wavelength conversion member and the red light and green light emitted from the wavelength conversion member.

In another embodiment, as the light source, a light source that emits ultraviolet light having a light emission center wavelength in a wavelength range of 300 nm to 430 nm, for example, an ultraviolet light emitting diode can be used. In this case, it is preferable that the wavelength conversion member 44 includes a quantum dot B that emits blue light excited by exciting light as well as quantum dots R and G. Thus, white light can be realized by the red light, the green light, and the blue light emitted from the wavelength conversion member.

In still another embodiment, a laser light source can be used instead of using a light emitting diode.

The light source to be provided may be a light source that emits blue light having a light emission center wavelength in a wavelength range of 430 to 500 nm, green light having a light emission center wavelength in a wavelength range of 500 to 600 nm, and red light having at least a part of the peak of the light emitting intensity in a wavelength range of 600 to 700 nm, and thus as embodiments other than the above light source, a white light source such as a white light emitting diode (LED) may be used.

In the case in which the backlight unit 40 has the light guide plate 43, the wavelength conversion member 44 is arranged on the path of the light emitted from the light guide plate 43. As the light guide plate 43, any known light guide plate can be used without limitation. In addition, the backlight unit 40 can include a reflecting member at the rear portion of the light source. The reflecting member is not particularly limited, and known reflecting members can be used. The reflecting members described in JP3416302B, JP3363565B, JP4091978B, or JP3448626B are exemplified, and the contents thereof are incorporated in the present invention.

The backlight unit 40 preferably also has a known diffusion plate or a diffusion sheet, a prism sheet (for example, BEF series, manufactured by Sumitomo 3M Ltd.), and a light guide. Other members described above are described in JP3416302B, JP3363565B, JP4091978B, and JP3448626B are exemplified, and the contents thereof are incorporated in the present invention.

In the liquid crystal display device including the above backlight unit, the drive mode of the liquid crystal cell is not particularly limited and various modes such as twisted nematic (TN), super twisted nematic (STN), vertical alignment (VA), in-plane switching (IPS), and an optically compensated bend cell (OCB) can be used. The liquid crystal cell is preferably a VA mode, an OCB mode, an IPS mode, or a TN mode, but is not limited thereto. The configuration of the liquid crystal display device in the VA mode may adopt the configuration shown in FIG. 2 of JP2008-262161A as an example. However, the specific configuration of the liquid crystal display device is not particularly limited and a known configuration can be adopted.

When the luminance improving film of the backlight unit includes the optical film of the present invention, the wavelength conversion region of particularly red and green light is widened and thus high luminance backlight and liquid crystal display device can be obtained.

### EXAMPLES

Hereinafter, the present invention will be more specifically described with reference to examples. The materials, reagents, amounts, proportions of substances, operations, and the like shown in the examples below may be changed as appropriate without departing from the spirit of the present invention. Therefore, the scope of the present invention is not to be interpreted as limiting to the examples shown below.

### Synthesis Example 1

(Synthesis Example of Polymer B-101)

Into a 200 ml three-neck flask equipped with a stirrer, a thermometer, a reflux cooling pipe, and a nitrogen gas introduction tube, 25.0 g of t-amyl alcohol was put, and the temperature was increased to 120° C. Next, a mixed solution of 3.25 g (7.8 mmol) of 2-(perfluorohexyl)ethyl acrylate, 2.26 g (4.7 mmol) of a trifunctional hydroxyl group-containing compound as monomer A shown below, 25.0 g of t-amyl alcohol, and 6.0 g of a polymerization initiator “V-601” (manufactured by Wako Pure Chemical Industries, Ltd.) was added dropwise thereto at a constant speed such that the dropwise addition was completed in 30 minutes. After the completion of the dropwise addition, stirring further continued for 3.5 hours and then the solvent was distilled away under reduced pressure. Drying was carried out at 130° C. under reduced pressure and thus 7.7 g of a polymer B-101 of the present invention was obtained. The weight-average molecular weight (Mw) of the polymer was 1,800. The weight-average molecular weight (Mw) was calculated by gel permeation chromatographyy (GPC) in terms of polystyrene. The columns used were TSKgel Super HZM-H, TSKgel Super HZ4000, and TSKgel Super HZ200 (manufactured by Tosoh Corporation).

The materials and contents in each synthesis example shown in Table 1 are shown below.

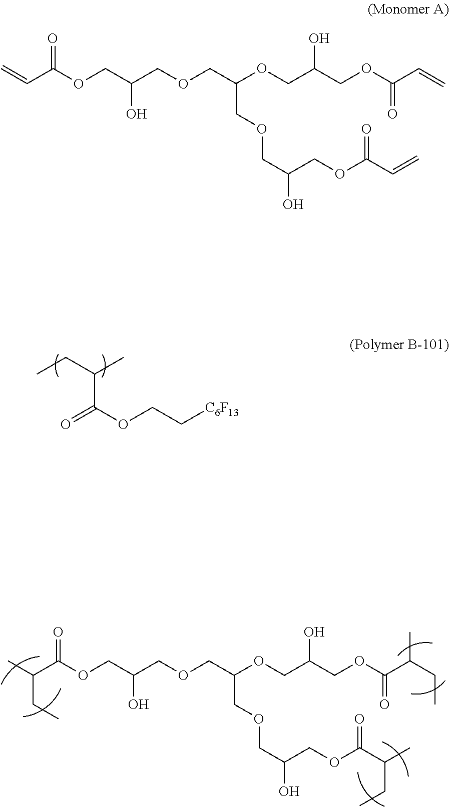

### Synthesis Examples 2 to 10

Polymers B-102 to B-110 of the present invention were synthesized in the same manner as in Synthesis Example 1 except that the monomer and compositional ratios were changed as shown in Table 1. The weight-average molecular weight (Mw) of each of Synthesis Examples 2 to 10 was 1,600 to 3,600.

Monomers B, C, and D used in Synthesis Examples 2 to 10 are shown below.

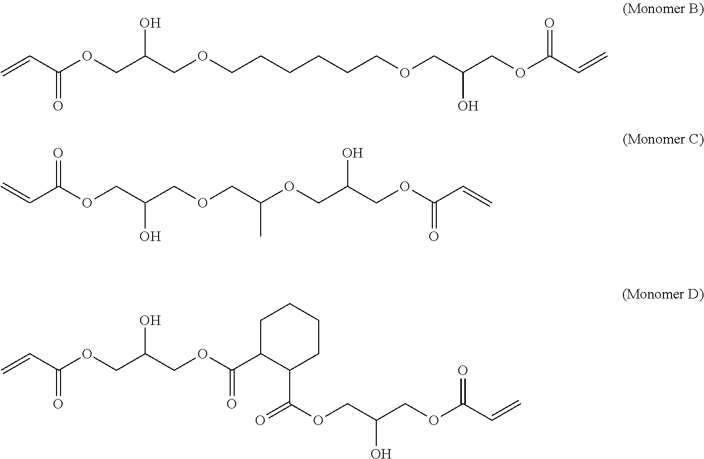

In Table 1, the materials, contents, and molecular weights of Synthesis Examples 1 to 10 are shown. In the table, a hydroxyl group-containing monomer refers to a compound having two or more radical polymerizable double bonds and one or more hydroxyl groups, and a fluorine-containing monomer refers to the above compound having a fluorine atom.

TABLE 1

| | | Hydroxyl | | | | | | | | |
|---|---|---|---|---|---|---|---|---|---|---|
| | | group-containing | | Fluorine-containing | | | | | | |
| | | monomer | | monomer | | Polymerization initiator | | Molecular weight (GPC) | | |
| | | Type | Parts by mass | Type | Parts by mass | Type | Amount [eq. (mol)]* | Mw (k) | Mn (k) | Mw/Mn |
| B-101 | Synthesis | A | 41 | C6FA | 59 | V-601 | 4.3 | 1.8 | 0.5 | 3.77 |
| | Example 1 | | | | | | | | | |
| B-102 | Synthesis | B | 41 | C6FA | 59 | V-601 | 3.4 | 1.8 | 0.7 | 2.68 |
| | Example 2 | | | | | | | | | |
| B-103 | Synthesis | C | 41 | C6FA | 59 | V-601 | 3.0 | 1.5 | 0.5 | 2.90 |
| | Example 3 | | | | | | | | | |
| B-104 | Synthesis | D | 24 | C10FA | 76 | V-601 | 6.9 | 1.6 | 0.5 | 3.24 |
| | Example 4 | | | | | | | | | |
| B-105 | Synthesis | A | 50 | C6FA | 50 | V-601 | 2.5 | 1.5 | 0.6 | 2.69 |
| | Example 5 | | | | | | | | | |
| B-106 | Synthesis | C | 44 | C8FA | 56 | V-601 | 2.8 | 1.9 | 0.6 | 3.19 |
| | Example 6 | | | | | | | | | |
| B-107 | Synthesis | B | 50 | C8FA | 50 | V-601 | 2.8 | 2.1 | 0.7 | 3.01 |
| | Example 7 | | | | | | | | | |
| B-108 | Synthesis | D | 30 | C6FA | 70 | V-601 | 5.2 | 1.6 | 0.7 | 2.29 |
| | Example 8 | | | | | | | | | |
| B-109 | Synthesis | A | 100 | Not used | — | V-601 | 9.2 | 3.6 | 0.9 | 4.12 |
| | Example 9 | | | | | | | | | |
| B-110 | Synthesis | A | 80 | C6FHA | 20 | V-601 | 2.0 | 3.1 | 0.7 | 4.44 |
| | Example 10 | | | | | | | | | |

*Equivalent with respect to bifunctional (polyfunctional) monomer

The abbreviations in Table 1 means as follows.
C6FHA: 1H,1H,7H-dodecafluoroheptyl acrylate
C6FA: 2-(perfluorohexyl)ethyl acrylate
C8FA: 2-(perfluorooctyl)ethyl acrylate
C10FA: 2-(perfluorodecyl)ethyl acrylate

<<Preparation of Optical Film>>

Optical films of Examples and Comparative Examples were prepared using the above-obtained polymers B-101 to B-110. The optical film was formed by sequentially laminating an alignment layer, a λ/4 layer, an alignment layer, a liquid crystal layer 1 (hereinafter, also referred to as an underlayer), and a liquid crystal layer 2 (hereinafter, also referred to as an upper layer) on a support. The method of forming each layer and coating solutions will be described below.

<Support: TD40UL>

As the support, a commercially available cellulose acylate film “TD40UL” (manufactured by Fujifilm Corporation) was used. Hereinafter, the support will be referred to as TD40UL.

<TD40UL+Alignment Layer>

The surface of TD40UL was treated with alkali and then an alignment layer was formed.

—Alkali Saponification Treatment—

TD40UL was allowed to pass through a dielectric heating roll at a temperature of 60° C. and the film surface temperature was increased to 40° C. Then, an alkali solution having the following composition was applied to one surface of the film using a bar coater to have a coating amount of 14 ml/m² and the film was transported under a steam type far-infrared heater manufactured by NORITAKE CO., LIMITED heated at 110° C. for 10 seconds. Subsequently, pure water was applied in an amount of 3 ml/m² using a bar coater in the same manner. Next, washing with water using a fountain coater and water removal using an air knife were repeated three times and then the film was transported to a drying zone at 70° C. for 10 seconds to be dried. Thus, a cellulose acylate film which had been subjected to an alkali saponification treatment was prepared.

——Composition of Alkali Solution——

| | |
|---|---|
| Potassium hydroxide | 4.7 parts by mass |
| Water | 15.8 parts by mass |
| Isopropanol | 63.7 parts by mass |
| Surfactant SF-1: C₁₄H₂₉O(CH₂CH₂O)₂₀H | 1.0 part by mass |
| Propylene glycol | 14.8 parts by mass |

—Formation of Alignment Layer—

An alignment layer coating solution having the following composition was continuously applied to the elongated cellulose acetate film which had been subjected to an alkali saponification treatment as described above using a #14 wire bar. The coating solution was dried at a temperature of 60° C. for 60 seconds and further dried at a temperature of 100° C. for 120 seconds. The obtained coating film was continuously subjected to a rubbing treatment to prepare an alignment layer. At this time, the longitudinal direction and the transport direction of the elongated film were parallel with each other, and the rotary shaft of a rubbing roller was oriented in a clockwise direction of 45° with respect to the longitudinal direction of the film.

—Composition of Alignment Layer Coating Solution——

| | |
|---|---|
| Modified polyvinyl alcohol below | 10 parts by mass |
| Water | 371 parts by mass |
| Methanol | 119 parts by mass |
| Glutaraldehyde | 0.5 parts by mass |
| Photopolymerization initiator (IRGACURE 2959, | 0.3 parts by mass |
| manufactured by BASF SE) | |

The structural formula of the modified polyvinyl alcohol in the alignment layer coating solution is shown below. In the following structural formula, the ratio is a molar ratio.

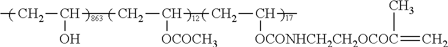

<TD40UL+Alignment Layer+λ/4 Layer>

A coating solution A1 including a disk-like liquid crystal compound having the following composition was continuously applied to the above-prepared alignment layer using a #3.6 wire bar. The transport speed (V) of the film was set to 20 m/min. In order to dry a solvent of the coating solution and age the alignment of the disk-like liquid crystal compound, the film was heated by hot air of a temperature 60° C. for 90 seconds. Subsequently, the alignment of the liquid crystal compound was fixed by irradiating the film with UV at 60° C., thereby forming a λ/4 layer. At this time, the amount of UV irradiation was set to 100 mJ/cm².

—Coating Solution A1 Used for λ/4 Layer—

| | |
|---|---|
| Disk-like liquid crystal compound (Compound 101) | 80 parts by mass |
| Disk-like liquid crystal compound (Compound 102) | 20 parts by mass |
| Alignment assistant 1 | 0.9 parts by mass |
| Alignment assistant 2 | 0.1 part by mass |
| Polymerizable monomer | 10 parts by mass |
| Surfactant (MEGAFAC F444 manufactured by DIC Corporation) | 0.12 parts by mass |
| Polymerization initiator 1 | 3 parts by mass |
| Acetone | 192.1 parts by mass |
| tert-Butanol | 54.9 parts by mass |
| Cyclohexanone | 27.5 parts by mass |

Compound 101 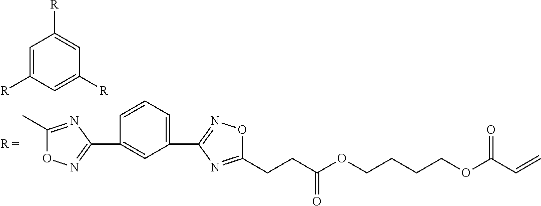
Compound 102 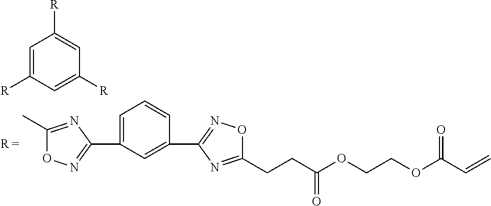
Alignment assistant 1 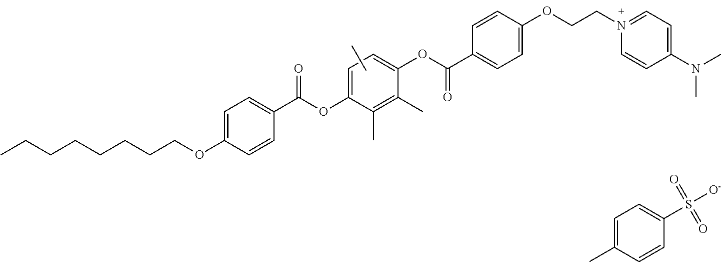
Alignment assistant 2 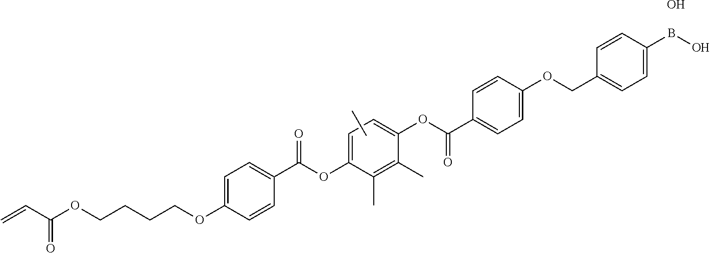
Polymerizable monomer 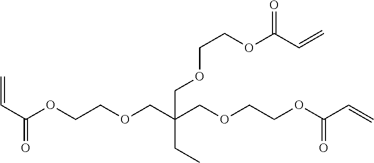 [SMILES: C=CC(=O)OCCOCC(CC)(COCCOC(=O)C=C)COCCOC(=O)C=C]
Polymerization initiator 1

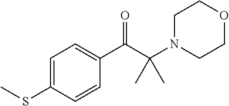 [SMILES: CSc1ccc(C(=O)C(C)(C)N2CCOCC2)cc1]

The above alignment assistants 1 and 2 are mixtures of two compounds in which the substitution positions of the methyl group in the respective trimethyl substituted benzene rings are different. The mixing ratio of two compounds is 50:50 by mass ratio.

Other coating solutions (A2 and A3) used for the λ/4 layer and the formation method will be described below.

The coating solution A2 including a disk-like liquid crystal compound having the following composition was continuously applied to the alignment layer using a #3.0 wire bar. The transport speed (V) of the film was set to 20 m/min. In order to dry a solvent of the coating solution and age the alignment of the disk-like liquid crystal compound, the film was heated by hot air of a temperature 60° C. for 60 seconds. Subsequently, the alignment of the liquid crystal compound was fixed by irradiating the film with UV at 70° C., thereby forming a λ/4 layer. At this time, the amount of UV irradiation was set to 200 mJ/cm²

—Coating Solution A2 Including Disk-Like Liquid Crystal Compound—

| | |
|---|---|
| Disk-like liquid crystal compound (Compound | 80 parts by mass |
| 101) | |
| Disk-like liquid crystal compound (Compound | 20 parts by mass |
| 102) | |
| Alignment assistant 1 | 0.9 parts by mass |
| Alignment assistant 2 | 0.1 parts by mass |
| Polymerizable monomer | 10 parts by mass |
| Surfactant (MEGAFAC F444 manufactured by | 0.12 parts by mass |
| DIC Corporation) | |
| Polymer B-101 of present invention | 0.03 parts by mass |
| Polymerization initiator 1 | 3 parts by mass |
| Methyl ethyl ketone | 218.7 parts by mass |
| tert-Butanol | 62.5 parts by mass |
| Cyclohexanone | 31.2 parts by mass |

The coating solution A3 including a disk-like liquid crystal compound having the following composition was continuously applied to the alignment layer using a #3.0 wire bar. The transport speed (V) of the film was set to 20 m/min. In order to dry a solvent of the coating solution and age the alignment of the disk-like liquid crystal compound, the film was heated by hot air of a temperature 60° C. for 60 seconds. Subsequently, the alignment of the liquid crystal compound was fixed by irradiating the film with UV at 70° C., thereby forming a λ/4 layer. At this time, the amount of UV irradiation was set to 200 mJ/cm²

—Coating Solution A3 Including Disk-Like Liquid Crystal Compound—

| | |
|---|---|
| Disk-like liquid crystal compound (Compound | 80 parts by mass |
| 101) | |
| Disk-like liquid crystal compound (Compound | 20 parts by mass |
| 102) | |
| Alignment assistant 1 | 0.9 parts by mass |
| Alignment assistant 2 | 0.1 parts by mass |
| Polymerizable monomer | 10 parts by mass |
| Polymer B-101 of present invention | 0.05 parts by mass |
| Polymerization initiator 1 | 3 parts by mass |
| Methyl ethyl ketone | 218.7 parts by mass |
| tert-Butanol | 62.5 parts by mass |
| Cyclohexanone | 31.2 parts by mass |

<TD40UL+Alignment Layer+λ/4 Layer+Alignment Layer>

An alignment layer was formed on the surface of the λ/4 layer in the same manner as described above.

<TD40UL+Alignment Layer+λ/4 Layer+Alignment Layer+Liquid Crystal Layer 1 (Underlayer)>

The following coating solution was continuously applied to the surface of the alignment layer formed on the λ/4 layer while adjusting the amount of coating solution so as to have a film thickness of 3 μm. Subsequently, the solvent was dried at 70° C. for 2 minutes to vaporize the solvent. Then, the film was thermally aged at 115° C. for 3 minutes and thus a uniform alignment state was obtained. Thereafter, the coating film was kept at 50° C. and irradiated with ultraviolet rays using a high pressure mercury lamp under a nitrogen atmosphere to form a cholesteric liquid crystal layer 1. At this time, the amount of UV irradiation was set to 75 mJ/cm².

(Preparation of Coating Solution B1 Used for Liquid Crystal Layer 1 of Example 1)

—Composition of Liquid Crystal Layer B1—

| | |
|---|---|
| Disk-like liquid crystal compound (Compound | 80 parts by mass |
| 101) | |
| Disk-like liquid crystal compound (Compound | 20 parts by mass |
| 102) | |
| Polymer B-101 of present invention | 0.05 parts by mass |
| Polymerization initiator 1 | 3 parts by mass |
| Chiral agent 1 | 5.5 parts by mass |
| Methyl ethyl ketone | 6.7 parts by mass |
| Acetone | 112.6 parts by mass |
| tert-Butanol | 38.8 parts by mass |
| Cyclohexanone | 15 parts by mass |

The chiral agent used in the composition of the liquid crystal layer B1 will be shown below.

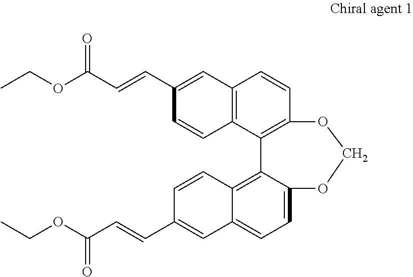

(Preparation of Coating Solution Used for Liquid Crystal Layers 1 of Examples 2 to 18 and Comparative Examples 1 to 4)

Coating solution B2 to B18 of the present invention and Coating solution BH-1 to BH-4 of Comparative Examples were prepared in the same manner as in the preparation of the coating solution B1 except that the amount and type of the polymer of the present invention added were changed as shown in Table 1.

(Coating Solution and Formation Method of Liquid Crystal Layer 1 in Example 19)

The following coating solution B19 was continuously applied to the surface of the alignment layer formed on the surface of the λ/4 layer of the above-described TD40UL+λ/4 layer while adjusting the amount of the coating solution so as to have a film thickness of 3.1 μm. Subsequently, the solvent was dried at 70° C. for 1 minute to vaporize the solvent. Then, the film was thermally aged at 112° C. for 2 minutes and thus a uniform alignment state was obtained.

Thereafter, the coating film was kept at 50° C. and irradiated with ultraviolet rays using a metal halide lamp manufactured by EYE GRAPHICS CO., LTD. under a nitrogen atmosphere to form a cholesteric liquid crystal layer B19. The nitrogen atmosphere refers to an environment of oxygen concentration of 500 ppm or less. At this time, the amount of UV irradiation was set to 130 mJ/cm².

—Coating Solution B19 of Liquid Crystal Layer 1 in Example 19—

| | |
|---|---|
| Disk-like liquid crystal compound (Compound | 80 parts by mass |
| 101) | |
| Disk-like liquid crystal compound (Compound | 20 parts by mass |
| 102) | |
| Surfactant (MEGAFAC F444 manufactured by | 0.18 parts by mass |
| DIC Corporation) | |
| Compound B-101 of present invention | 0.03 parts by mass |
| Polymerization initiator 1 | 3 parts by mass |
| Chiral agent 1 | 5.1 parts by mass |
| Methyl ethyl ketone | 125.2 parts by mass |
| tert-Butanol | 38.5 parts by mass |
| Cyclohexanone | 28.9 parts by mass |

(Coating Solution and Formation Method of Liquid Crystal Layer 1 in Example 20)

The following coating solution B20 was continuously applied to the surface of the alignment layer formed on the surface of the λ/4 layer of the above-described TD40UL+λ/4 layer while adjusting the amount of the coating solution so as to have a film thickness of 3.1 μm. Subsequently, the solvent was dried at 70° C. for 1 minute to vaporize the solvent. Then, the film was thermally aged at 112° C. for 2 minutes and thus a uniform alignment state was obtained.

Thereafter, the coating film was kept at 50° C. and irradiated with ultraviolet rays using a metal halide lamp manufactured by EYE GRAPHICS CO., LTD. under a nitrogen atmosphere to form a cholesteric liquid crystal layer B20. The nitrogen atmosphere refers to an environment of oxygen concentration of 500 ppm or less. At this time, the amount of UV irradiation was set to 130 mJ/cm².

—Coating solution B20 of Liquid Crystal Layer 1 in Example 20—

| | |
|---|---|
| Disk-like liquid crystal compound (Compound | 80 parts by mass |
| 101) | |
| Disk-like liquid crystal compound (Compound | 20 parts by mass |
| 102) | |
| Compound B-101 of present invention | 0.05 parts by mass |
| Polymerization initiator1 | 3 parts by mass |
| Chiral agent1 | 5.1 parts by mass |
| Methyl ethyl ketone | 125.2 parts by mass |
| tert-Butanol | 38.5 parts by mass |
| Cyclohexanone | 28.9 parts by mass |

<TD40UL+λ/4 Layer+Alignment Layer+Liquid Crystal Layer 1+Liquid Crystal Layer 2 (Upper Layer)>

A coating solution C1 including a rod-like liquid crystal compound having the following composition was continuously applied to the surface of the liquid crystal layer 1 prepared using the above coating solution B1 while adjusting the amount of the coating solution so as to have a film thickness of 5 μm. The transport speed of the film was set to 20 m/min. In order to dry a solvent of the coating solution and age the alignment of the rod-like liquid crystal compound, the film was heated by hot air of a temperature 95° C. for 180 seconds. Subsequently, the alignment of the liquid crystal compound was fixed by irradiating the film with UV at 30° C., thereby forming an optically anisotropic layer (liquid crystal layer 2). At this time, the amount of UV irradiation was set to 300 mJ/cm².

In Examples 1 to 20 and Comparative Examples 1 to 4, a liquid crystal layer 2 was formed in the same manner.

—Coating Solution C1 of Liquid Crystal Layer 2—

| | |
|---|---|
| Rod-like Liquid Crystal Compound 201 | 83 parts by mass |
| Rod-like Liquid Crystal Compound 202 | 15 parts by mass |
| Rod-like Liquid Crystal Compound 203 | 2 parts by mass |
| Polyfunctional monomer A-TMMT (manufactured by SHIN-NAKAMURA CHEMICAL CO., LTD.) | 1 part by mass |
| Polymerization initiator IRGACURE 819 (manufactured by BASF SE) | 4 parts by mass |
| Fluorine-containing compound 1 | 0.17 parts by mass |
| Chiral agent LC756 (manufactured by BASF SE) | 6 parts by mass |
| Toluene | 187.5 parts by mass |
| Cyclohexanone | 9.9 parts by mass |

Rod-like liquid crystal compound 201 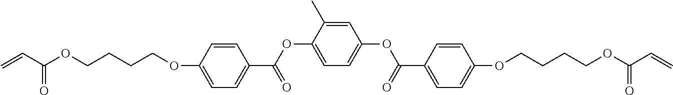 [SMILES: C=CC(=O)OCCCCOc1ccc(C(=O)Oc2ccc(OC(=O)c3ccc(OCCCCOC(=O)C=C)cc3)c(C)c2)cc1]
Rod-like liquid crystal compound 202 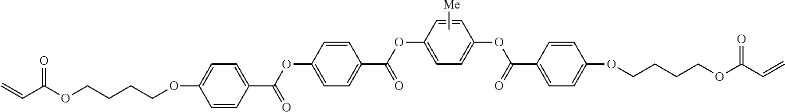
Rod-like liquid crystal compound 203 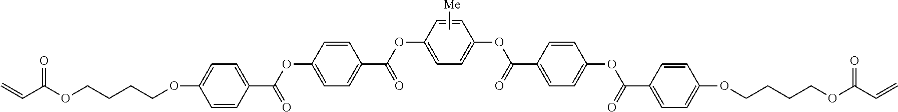
(Fluorine-containing compound 1)

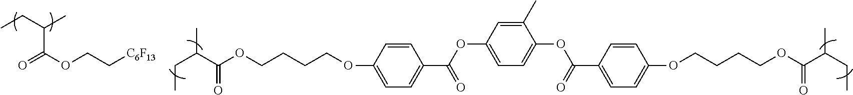

### Comparative Synthesis Example 1

Into a 200 ml three-neck flask equipped with a stirrer, a thermometer, a reflux cooling pipe, and a nitrogen gas introduction tube, 25.0 g of toluene was put, and the temperature was increased to 120° C. Next, a mixed solution of 3.25 g (7.8 mmol) of 2-(perfluorohexyl)ethyl acrylate, 2.26 g (5.3 mmol) of a trimethylolpropane triacrylate, 25.0 g of toluene, and 4.7 g of a polymerization initiator “V-601” (manufactured by Wako Pure Chemical Industries, Ltd.) was added dropwise thereto at a constant speed such that the dropwise addition was completed in 30 minutes. After the completion of the dropwise addition, stirring further continued for 3.5 hours and then the solvent was distilled away under reduced pressure. Drying was carried out at 130° C. under reduced pressure and thus 7.5 g of a polymer (H-101) of Comparative Example was obtained. The weight-average molecular weight (Mw) of the polymer was 1,500. The weight-average molecular weight (Mw) was calculated by gel permeation chromatographyy (GPC) in terms of polystyrene. The columns used were TSKgel Super HZM-H, TSKgel Super HZ4000, and TSKgel Super HZ200 (manufactured by Tosoh Corporation).

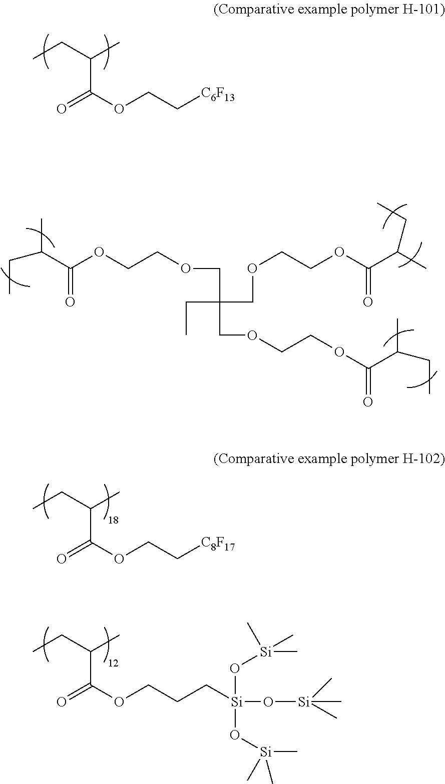

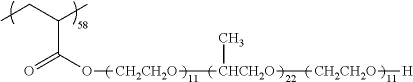

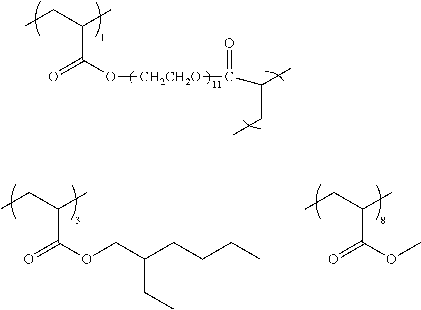

(Comparative Example Compound H-103)

A commercially available fluorine-based surface modifier “MEGAFAC F-552” (product name, manufactured by DIC Corporation) was used.

(Viscosity Measurement of Coating Solution)

The viscosity of the coating solutions B1 to B20, BH-1 to BH-4, and C1 was measured using a vibration type viscometer (product name “Vm-100”, manufactured by SEIKONIC CORPORATION). The viscosity of the all coating solutions was within a range of 1.5 to 10 mPa·s.

The liquid crystal layer 1 and the liquid crystal layer 2 of each of the prepared optical films was respectively applied and dried and then the following items were evaluated. The results are shown in Table 2.

<Cissing>

The number of cissing in the layer formed using each composition in the film of a size of 15 cm×20 cm in each of Examples and Comparative Examples was counted. Here, a region on the surface of the underlayer in which an upper layer was not formed was counted as one cissing defect. Based on the results, evaluation was carried out based on the following criteria.

When the evaluation criteria is A or B, the production efficiency is excellent, it is possible to suitably use the film. It is more preferable that the evaluation criteria is A.

A: The number of cissing is 1 or less.

B: The number of cissing is 2 to 3.

C: The number of cissing is 4 to 9.

D: The number of cissing is more than 10.

<Surface Condition>

The composition was applied and dried and then the surface condition of the layer was visually observed.

When the evaluation criteria is A or B, the production efficiency is excellent, it is possible to suitably use the film. It is more preferable that the evaluation criteria is A.

A: The surface does not have dry unevenness and wrinkles.

B: Slight dry unevenness is observed but the film can be used without a problem.

C: The amount of dry unevenness and roughness is large compared to B but the film can be used without a problem.

D: The roughness caused by dry unevenness is apparently observed and the film is not suitable to be used.

<Alignment>

The deterioration in the liquid crystal alignment was determined based the presence or absence of orientation defects when the film was observed using a deflection microscope (product name “ECLIPSE”, manufactured by Nikon Corporation) according to the following criteria. It is preferable that the evaluation criteria maybe any of A to C. When the evaluation criteria is A or B, the production efficiency is excellent, it is possible to suitably use the film. It is more preferable that the evaluation criteria is A.

A: No orientation defect exists.

B: Almost no orientation defect exists.

C: Orientation defect exists in some parts.

D: Orientation defects exist on the whole surface.

<Liquid Crystal Display Device>

When a commercially available liquid crystal display device (product name “TH-L42D2”, manufactured by Panasonic Corporation) was disassembled and the luminance improving film in the backlight unit thereof was changed to the optical film of the present invention to form a liquid crystal display device of the present invention, the performance was good.

TABLE 2

| | | | | | Polymer of | | | | | | | |
|---|---|---|---|---|---|---|---|---|---|---|---|---|
| | | | | | present invention | | | | | | | |
| | | | | | | Amount of | | | | | | |
| | | Coating solution | | | | addition | Performance (underlayer) | | | Performance (upper layer) | | |
| | | λ/ | | Upper | | (parts | | Surface | | | Surface | |
| | Support | 4 Layer | Underlayer | layer | Type | by mass) | Cissing | condition | Alignment | Cissing | condition | Alignment |
| Example 1 | TD40UL | A1 | B1 | C1 | B-101 | 0.05 | A | A | A | A | A | A |
| Example 2 | TD40UL | A1 | B2 | C1 | B-102 | 0.04 | A | A | A | A | A | A |
| Example 3 | TD40UL | A1 | B3 | C1 | B-103 | 0.07 | A | A | A | A | A | A |
| Example 4 | TD40UL | A1 | B4 | C1 | B-104 | 0.05 | A | A | A | A | A | A |
| Example 5 | TD40UL | A1 | B5 | C1 | B-105 | 0.06 | A | A | A | A | A | A |
| Example 6 | TD40UL | A1 | B6 | C1 | B-106 | 0.05 | A | A | A | A | A | A |
| Example 7 | TD40UL | A1 | B7 | C1 | B-107 | 0.04 | A | A | A | A | A | A |
| Example 8 | TD40UL | A1 | B8 | C1 | B-108 | 0.07 | A | A | A | A | A | A |
| Example 9 | TD40UL | A1 | B9 | C1 | B-109 | 0.08 | B | B | B | A | A | B |
| Example 10 | TD40UL | A1 | B10 | C1 | B-110 | 0.05 | B | B | B | A | B | A |
| Example 11 | TD40UL | A1 | B11 | C1 | B-101 | 0.1 | A | A | A | A | A | A |
| Example 12 | TD40UL | A1 | B12 | C1 | B-103 | 0.25 | A | A | B | A | A | B |
| Example 13 | TD40UL | A1 | B13 | C1 | B-105 | 0.2 | A | A | B | A | A | B |
| Example 14 | TD40UL | A1 | B14 | C1 | B-101 | 0.5 | A | A | B | A | A | B |
| Example 15 | TD40UL | A1 | B15 | C1 | B-102 | 0.4 | A | A | B | A | A | B |
| Example 16 | TD40UL | A1 | B16 | C1 | B-104 | 0.7 | A | A | B | A | A | B |
| Example 17 | TD40UL | A1 | B17 | C1 | B-106 | 0.02 | B | A | A | A | A | A |
| Example 18 | TD40UL | A1 | B18 | C1 | B-107 | 0.01 | B | A | A | B | A | A |
| Example 19 | TD40UL | A2 | B19 | C1 | B-101 | 0.03 | A | A | A | A | A | A |
| Example 20 | TD40UL | A3 | B20 | C1 | B-101 | 0.05 | A | A | A | A | A | A |
| Comparative | TD40UL | A1 | BH-1 | C1 | H-101 | 0.25 | D | D | D | C | C | C |
| Example 1 | | | | | | | | | | | | |
| Comparative | TD40UL | A1 | BH-2 | C1 | H-102 | 0.2 | D | D | D | C | C | C |
| Example 2 | | | | | | | | | | | | |
| Comparative | TD40UL | A1 | BH-3 | C1 | H-103 | 0.3 | D | D | D | C | C | C |
| Example 3 | | | | | | | | | | | | |
| Comparative | TD40UL | A1 | BH-4 | C1 | Not used | — | D | A | A | C | A | A |
| Example 4 | | | | | | | | | | | | |

As seen from the Table 2, in Examples 1 to 20 using the polymer of the present invention, good results could be obtained in all evaluation items of cissing, surface condition, and alignment. Particularly, in all Examples 1 to 8 including a partial structure formed by copolymerizing the compound having a radical polymerizable double bond and a fluorine atom with the polymer, the underlayer and upper layer evaluation was A and was excellent compared to Example 9 in which the compound having a fluorine atom was not copolymerized.

In Examples 19 and 20, even in the case in which the polymer of the present invention was added to the λ/4 layer and applied, and the liquid crystal layer 1 containing the polymer of the present invention was applied, all performance was evaluated as A. It was found that the polymer of the present invention was effective in improvement of cissing or the like even in the case of lamination application.

In Examples 1 to 8, 11, 19, and 20 in which the amount of the polymer of the present invention added was 0.03 to 0.1 parts by mass, all the underlayer and upper layer evaluation items were A or higher and the evaluation results were excellent.

Examples 1, 2, and 4 in which the amount of the polymer of the present invention added was 0.04 to 0.05 parts by mass were excellent in alignment compared to Examples 14 to 16 in which the same polymer was used and the amount of the polymer added was 0.4 to 0.7 parts by mass.

In Example 7 in which the amount of the polymer of the present invention added was 0.04 parts by mass, the cissing evaluation was excellent compared to Example 18 in which the amount of the polymer added was 0.01 parts by mass.

Since the content of fluorine atom in the compound having a fluorine atom of Example 10 was low compared to Examples 1 to 3, the surface tension was increased and the performance was lowered.

On the other hand, in all Comparative Example 1 not having a hydroxyl group, Comparative Example 2 including the polymer not having two or more radical polymerizable double bonds, and Comparative Example 3 including a conventional fluorine-based surfactant, the underlayer evaluation was D and deteriorated. In Comparative Example 4 not containing the polymer of the present invention, the cissing evaluation was D and deteriorated.

What is claimed is:

1. A polymer obtained by polymerizing a monomer having two or more radical polymerizable double bonds and one or more hydroxyl groups.

2. The polymer according to claim 1, wherein the monomer is represented by the following Formula X,
Z^{X1}-L^{X1}-L^{X2}-ML^{X3}-L^{X4}-Z^{X2})ₙ Formula X
in Formula X, Z^{X1} and Z^{X2} each independently represent a group having a radical polymerizable double bond, L^{X1} and L^{X4} each independently represent a single bond or an alkylene group having a hydroxyl group, L^{X2} and L^{X3} each independently represent a single bond or a divalent linking group including at least one selected from the group consisting of —O—, —(C═O)O—, —O(C═O)—, a divalent chained group, an alkylene group having a hydroxyl group, and a divalent cyclic aliphatic group, M represents a single bond or a divalent to tetravalent linking group, and n represents an integer of 1 to 3.

3. The polymer according to claim 2, wherein the monomer is represented by the following Formula X1, 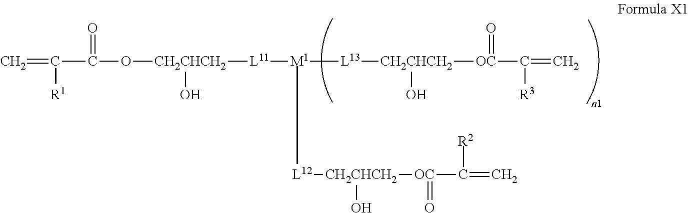
in Formula X1, R¹, R², and R³ each independently represent a hydrogen atom or an alkyl group having 1 to 20 carbon atoms, L¹¹, L¹², and L¹³ each independently represent a single bond or a divalent linking group including at least one selected from the group consisting of —O—, —(C═O)O—, —O(C═O)—, a divalent chained group, an alkylene group having a hydroxyl group, and a divalent cyclic aliphatic group, M¹ represents a single bond or a divalent or trivalent linking group, and n1 represents an integer of 0 to 2.

4. The polymer according to claim 1 having a partial structure formed by polymerizing a compound having a fluorine atom.

5. The polymer according to claim 4, wherein the compound having a fluorine atom is represented by the following Formula a, 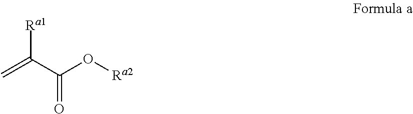
in Formula a, R^{a1} represents a hydrogen atom or an alkyl group having 1 to 20 carbon atoms, and R^{a2} represents an alkyl group having 1 to 20 carbon atoms of which at least one carbon atom has a fluorine atom as a substituent.

6. The polymer according to claim 1, wherein a weight-average molecular weight is 1,000 to 300,000 in terms of polystyrene by gel permeation chromatography.

7. The polymer according to claim 6, wherein the weight-average molecular weight is 1,000 to 10,000 in terms of polystyrene by gel permeation chromatography.

8. The polymer according to claim 1 having a highly branched structure.

9. A composition comprising the polymer according to claim 1.

10. The composition according to claim 9, further comprising a liquid crystal compound.

11. The composition according to claim 10, wherein the liquid crystal compound is a polymerizable liquid crystal compound.

12. The composition according to claim 11, wherein the polymerizable liquid crystal compound is at least one of a polymerizable rod-like liquid crystal compound or a polymerizable disk-like liquid crystal compound.

13. An optical film comprising a cholesteric liquid crystal layer containing the polymer according claim 1 on a support.

14. The optical film according to claim 13 having a structure formed by laminating a plurality of the cholesteric liquid crystal layers.

15. The optical film according to claim 14, wherein the plurality of the cholesteric liquid crystal layers comprise a cholesteric liquid crystal layer including a rod-like liquid crystal compound and a cholesteric liquid crystal layer including a disk-like liquid crystal compound.

16. The optical film according to claim 15, wherein the cholesteric liquid crystal layer including the rod-like liquid crystal compound and the cholesteric liquid crystal layer including the disk-like liquid crystal compound are in contact with each other.

17. A liquid crystal display device comprising at least:
a backlight unit including the optical film according to claim 13; and
a liquid crystal cell.
